(19) United States
(12) Patent Application Publication
(10) Pub. No.: US 2010/0299160 A1
(43) Pub. Date: Nov. 25, 2010

(54) SYSTEM AND METHOD FOR PROVIDING FLEXIBLE AND PREDICTABLE INCOME

(75) Inventors: Michael J. Roscoe, South Windsor, CT (US); Philip W. Michalowski, Glastonbury, CT (US); Keith E. Golembiewski, Suffield, CT (US); David P. Wiland, Norristown, PA (US); Rodney R. Howard, Weatogue, CT (US); Sarah M.S. Raji, Tolland, CT (US)

Correspondence Address: Howard IP Law Group, P.O. Box 226, Fort Washington, PA, 19034, US

(73) Assignee: HARTFORD FIRE INSURANCE COMPANY, Hartford, CT (US)

(21) Appl. No.: 12/634,903

(22) Filed: Dec. 10, 2009

Related U.S. Application Data
(60) Provisional application No. 61/179,608, filed on May 19, 2009.

(51) Int. Cl. G06Q 40/00; G06Q 20/00

(52) U.S. Cl. 705/4; 705/37; 705/36 R

(57) ABSTRACT

A computer system for administering a retirement income guarantee contract includes a communications module for receiving and transmitting data, and an administration module. The administration module has: an account initiation module for storing contract data including: an initial premium amount paid on which an accumulation balance is initially based; a target payout commencement date and a payout commencement date range including the target payout commencement date; payout rates fixed at the time of payment of the initial premium amount for determining income payments for payouts commencing at dates within the range; and one or more crediting rates fixed at the time of payment of the initial premium amount for determining increases in accumulation balance until the payout date. A payout administration module determines a payout amount based on the accumulation balance at the payout date and the fixed payout rate applicable to the payout date.

### RELATED APPLICATIONS

This application claims the benefit under 35 U.S.C. 119(e) of U.S. Provisional Patent Application Ser. No. 61/179,608, filed May 19, 2009, which application is incorporated herein by reference in its entirety for all purposes.

### FIELD OF INVENTION

The present invention relates to computer systems, and particularly to computer systems for administering financial products, such as annuities, for providing retirement income.

### BACKGROUND

In planning for retirement, there are a wide variety of options available as investment products. Individual investment and savings products, such as 401(k) plans and other types of accounts, provide a convenient avenue for saving and investing in advance of retirement. Individuals can structure payments so that they know the value of contributions into a retirement plan. The income available depends on a combination of amounts invested, returns on investment, and the individual s assessment of individual s needs and likely longevity. The individual has flexibility as to the amount and timing of withdrawals from investments as income, but lacks certainty as to the amount available. The individual must balance amounts of annual withdrawals against anticipated life expectancy. The individual may live longer than anticipated and outlive the retirement savings. The individual may not live as long as anticipated and may unnecessarily compromise the individual s lifestyle during retirement.

An alternative to investment products similar to 401(k) plans is the deferred annuity. There are a wide variety of deferred annuity products available with various features. A deferred annuity is a contract under which an investor pays an insurance company a lump sum amount, in exchange for a promise to begin periodic payments continuing for a lifetime, after an accumulation period. The amount of the payment is determined according to the balance of the annuity after the accumulation period and an insurance company assigned payout rate at the time the payments commence. The deferred annuity provides uncertainty in the amount of the payments, as the payout rate is not known at the time the lump sum investment is made.

A fixed payout annuity commences payment of a particular amount at a particular age or date in the future. The lack of flexibility in the amount of the payments and the date the payments begin is a disadvantage for many individuals who consider fixed payout annuities. A fixed payout annuity, unlike a 401(k) or other retirement savings account, has no stated value; accordingly, the purchaser feels that nothing has been obtained in exchange for the premium payment. Producers do not typically receive a commission based on funds under management in connection with a fixed payout annuity.

### SUMMARY

In one embodiment, a computer system for administration of a retirement income guarantee contract has: a communications module for providing retirement income guarantee contract data including: an identity of a contract owner; an initial premium amount paid; a target payout commencement date; an age of a measuring life; a payout commencement range including the target payout commencement date; and further for providing an output signal indicative of a payout commencement date selected by the contract owner; an account initiation module for determining payout rates fixed at the time of payment of the initial premium amount use in calculating income payments for payout commencing at dates within the payout commencement range; and credited interest rates fixed at the time of payment of the initial premium amount for determining increases in accumulation balance until the payout commencement date; a contract generation module for receiving data from the communications module and the account initiation module, generating a contract based on the received data and furnishing the contract to the contract owner; an accumulation administration module configured to determine an initial benefit balance based on the initial premium amount, updated benefit balances based on the benefit balance and the fixed credited interest rates, and store the determined benefit balances; a payout administration module configured for, responsive to receiving from the communications module a payout commencement date within the payout commencement range and a payout value, determining a payout amount, paid at periodic intervals for a lifetime of the at least one annuitant, based on the payout value as of the payout commencement date and the fixed payout rates.

In an embodiment, a computer system for administering a retirement income guarantee contract has a communications module for receiving and transmitting data; a data storage device for storing payout rate data and credited rate data; an account initiation module for: causing to be stored in the data storage device retirement income guarantee contract data including: an identity of a contract owner, an initial premium amount paid, and a selected target payout commencement date, received via the communications module; a payout commencement date range; and for accessing from the data storage device payout rates fixed at the time of payment of the initial premium amount for determining income payments upon commencement of payouts at a payout date to be selected in the future by the contract owner within the payout commencement date range; and one or more crediting rates fixed at the time of payment of the initial premium amount for determining increases in an accumulation balance until commencement of payout at a payout date selected by the contract owner in the future; and a contract generation module for generating a contract based on the retirement income guarantee contact data and furnishing the contract to the contract owner.

In an embodiment, a computer-implemented method for administering a retirement income guarantee contract, includes storing in a memory by an account initiation module including a processor, retirement income guarantee contract data including: an identity of a contract owner; an age of a measuring life; an initial premium amount paid; a selected target payout commencement date; a payout commencement date range including the target payout commencement date; an accumulation balance based on the initial premium amount paid; accessing from a memory device by the account initiation module payout rates fixed at the time of payment of the initial premium amount for determining payout amounts upon commencement of payouts within the payout commencement date range, and one or more crediting rates fixed at the time of payment of the initial premium amount for determining increases in accumulation balance until commencement of payout at a payout date selected by the contract owner in the future; and generating by a contract generation module a contract based on the retirement income guarantee contract data and furnishing the contract to the contract owner.

In an embodiment, a computer-readable medium has instructions thereon which, when executed by a processor, cause the processor to: store in a memory retirement income guarantee contract data including: an identity of a contract owner; an age of a measuring life; an initial premium amount paid; a selected target payout commencement date; a payout commencement date range including the target payout commencement date; and an accumulation balance based on the initial premium amount paid; access from a memory device payout rates fixed at the time of payment of the initial premium amount for determining payout amounts upon commencement of payouts within the payout commencement date range, and one or more crediting rates fixed at the time of payment of the initial premium amount for determining increases in accumulation balance until commencement of payout at a payout date selected by the contract owner in the future; and generate by a contract generation module a contract based on the retirement income guarantee contract data and furnishing the contract to the contract owner.

In an embodiment, a computer-implemented method for administration of retirement income guarantee contract owned by a contract owner, includes: accessing by an accumulation module, having a processor, in an administration system from a memory device accumulation balance data and stored credited rate data; determining by the accumulation module an updated accumulation balance based on the stored accumulation balance data and stored credited rate data; determining by an administration system having a processor whether a payout date has been received; responsive to determining that no payout date has been received, maintaining the accumulation balance without deduction for payouts; and, if a payout date has been received, determining a payout amount based on stored payout rates if the payout date is within a stored payout commencement date range, and independent of the stored payout rates otherwise; determining by a death benefit module whether data indicative of a death of the contract owner has been received, and responsive to determining that no data indicative of the death of the contract owner has been received, storing in memory an indication that the contract owner is living; and determining by a redemption module whether data indicative of a request for redemption of the balance has been received, and responsive to determining that no data indicative of a request for redemption has been received, maintaining the account.

In an embodiment, a computer system for administration of a retirement income guarantee contract includes a processor and a memory storage device in communication with the processor. The processor is configured to: access from the memory storage device data indicative of an identity of a measuring life, an age of a measuring life, an initial premium amount, and a selected target payout commencement date; determine and store in the memory storage device a target payout commencement date range including the target payout commencement date; determine, based on the target payout commencement date range and the age of the measuring life, fixed payout rates for payouts commencing at dates within the target payout commencement date range, and store the fixed payout rates in the memory storage device; determine fixed interest rates for crediting interest to an account balance and store the fixed interest rates in the memory storage device; determine and store in the memory storage device an initial account balance based on the initial premium amount; determine and store in the memory storage device updated account balances periodically based on the initial account balance and the fixed interest rates; determine whether a received payout commencement date is within the target payout commencement date range, and, responsive to determining that the received payout commencement date is within the target payout commencement date range, determine a payout amount based on an account balance as of the payout commencement date and one of the fixed payout rates applicable to the payout commencement date; and responsive to determining that the received payout commencement date is not within the target payout commencement date range, determine a payout amount independent of the fixed payout rates; and provide an output signal having data indicative of the determined payout amount.

### BRIEF DESCRIPTION OF THE FIGURES

FIG. 1 is a schematic diagram of an exemplary computer system for implementation of a method and system of the invention.

FIG. 2 is a schematic diagram of an exemplary network for implementation of a method and system of the invention.

FIG. 3 is a schematic diagram illustrating an exemplary computer system for implementation of a method and system of the invention.

FIG. 4 is a flow diagram illustrating a method performed by an illustration module of a computer system of the invention.

FIGS. 5A and 5B are screenshots of screens provided by an illustration tool implemented by a computer system of the invention and displayed on a client device.

FIG. 5C is an illustration in the form of a spreadsheet illustrating exemplary calculations performed by an illustration tool in a computer system of the invention and displayed on a client device.

FIG. 6 is an exemplary illustration displayed on a smart phone by an illustration module of a computer system of the invention.

FIG. 7 is a schematic diagram illustrating components of an exemplary processing module of a computer system of the invention.

FIG. 8 is a process flow diagram illustrating a method performed by a payout determination module of FIG. 7.

FIG. 9 is a process flow diagram illustrating a method performed by account initiation module of FIG. 7.

FIG. 10 is a process flow diagram illustrating a method performed by accumulation module of FIG. 7.

FIG. 11 is a process flow diagram illustrating a method performed by the payout administration module of FIG. 7.

FIG. 12 is a process flow diagram illustrating a method performed by commutation module of FIG. 7.

FIG. 13 is a process flow diagram illustrating a method performed by a death benefit module of FIG. 7.

FIG. 14 is a chart illustrating an embodiment of a system of the invention.

FIG. 15 is a schematic diagram illustrating the use of different computer systems to administer accounts before and after the annuity commencement date.

FIG. 16 is a screen shot showing a operation in an account initiation module in a pre-annuitization account administration system.

FIG. 17 is a page showing the credited interest rate of 3% applicable to the retirement income guarantee account portion of an annuity.

FIG. 18 shows a display on a user device of a summary of a retirement income guarantee contract, including payments to an annuitant other than the contract owner.

FIG. 19 shows a display on a screen of a pre-annuitization account administration system permitting a user to select a new credited rate and a duration for the rate.

FIG. 20 shows a display, which may be displayed on a user device by an illustration module of a system, of an illustration of an account.

FIG. 21 shows a display, which may be displayed on a user device by an illustration module of a system, of an illustration of an alternative account.

FIG. 22 is a schematic view of a system for administration of a guaranteed retirement income account as a subaccount in an annuity contract.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for administration of accounts for annuities and other financial products. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

A challenge in the field of retirement planning is providing financial products and services to provide income in retirement, while avoiding investment risk and longevity risk, and providing a level of flexibility for the individual.

In an embodiment, a system and method provide flexible and predictable income. A retirement income guarantee contract may be established. Under the retirement income guarantee contract, an initial premium payment is made by or on behalf of an account owner to an insurance company to establish a retirement income account having an accumulation balance. At the time of establishment of the account, rates for crediting of interest on the accumulation balance are determined and stored. A target payout commencement date, which is a fixed point in time, such as a certain year, from the initial premium payment, is fixed and stored at the time of the initial premium payment. A range of payout commencement dates around the target payout commencement date, such as three years before and three years after the target payout commencement date, is fixed at the time of the initial premium payment. Payout rates for payouts commencing at dates within the range, and continuing periodically for a lifetime, are fixed at the time of the initial premium payment. The account has a balance, which is initially the initial premium payment, less initial charges. The accumulation balance is increased according to formulas for calculation of credited rates. The account owner selects and communicates a date for commencement of payouts. The account owner also communications an indication either that the basis for the payouts is to be the entire accumulation balance, or that the basis is to be a selected amount or percentage of the accumulation balance. As of the selected payout commencement date, the balance subject to payout, which may be called the payout balance, ceases to increase in accordance with a credited rate. If the selected payout commencement date is within the range, the payout amount is determined according to the payout rate fixed at the time of the initial premium payment. If the selected payout commencement date is outside the range, the payout amount is determined according to a payout rate determined by the insurance company. Thereafter, payouts are made for a lifetime of a measuring life. The measuring life may be a contract owner or another annuitant. The term annuitant is used herein to indicate an individual who is both a measuring life and a recipient of income. In any embodiment, the measuring life and the recipient of income may be separate individuals or the same individual. The payout amounts decrease the account balance. The arrangement provides for fixed accumulation rates, and fixed annuity payout rates with a range of options for selection of commencement of payout.

A contract owner may select a payout date and designate that the entire account balance or a portion of the account balance (the payout balance) is to be used as the basis for the payout. If a portion of the account balance is to be used as the basis for the payout, then the remaining portion of the account balance continues to serve as the basis for credited interest payments.

The arrangement may be implemented as a subaccount in an annuity account. The account balance may be increased by transfers from other subaccounts as well as by premiums and contributions after the initial premium payment. The target payout commencement date and the range are the same for all premiums, contributions and transfers to the same account. The credited rates and payout rates are fixed at the time of each premium, contribution or transfer. Thus, the credited rates and payout rates for different tranches within an account may be different.

An annuity contract, and particularly a deferred annuity contract, may provide for an initial premium to be paid by a contract owner to an insurance company. The annuity contract may provide for an accumulation phase, during which the annuity has an account value. In fixed annuities, the insurance company may credit a market rate, generally determined on a periodic basis, such as annually, to the account value. The account value increases during the accumulation phase in accordance with this periodically determined interest rate. The contract owner thus knows that the balance will increase during the accumulation phase, but does not know how quickly the balance will increase. In a variable annuity, during the accumulation phase, the contract owner has the right to allocate funds making up the account value to one or more subaccounts. Each subaccount may have a rate of return based on the rate of return of an investment fund selected by the contract owner. The available investment funds may include a wide range of available mutual funds, such as stock mutual funds with various investment guidelines, fixed income mutual funds, exchange traded funds, and other types of funds. The portion of the account value allocated to each fund varies along with the performance of the fund, so that the account value may both increase and decrease. The variable annuity permits the contract owner to enjoy the possible upside of fund returns that are greater than the contractual returns provided by an insurance company in a fixed annuity. However, the variable annuity carries with it the risk of a reduction in account value. The contract owner is generally permitted to change the allocation of the fund value among investment vehicles. The contract owner may generally make contributions to the account, and select how the contributions are allocated. Periodic charges are generally deducted from the accounts. These charges represent, for example, insurance related charges, such as mortality and administration fees. For variable annuity subaccounts, management fees are generally deducted.

The contract owner may obtain access to the account funds of an annuity during the accumulation phase by withdrawing funds from the account. Such withdrawals may be subject to charges, particularly if the withdrawal is a short period of years after establishment of the account. The contract owner may elect to annuitize the value of the account, by converting the value of the account to an annuity that pays a periodic amount, generally for the lifetime of an annuitant. When the account is annuitized, the accumulation phase is concluded; once the account is annuitized, the account no longer has an account value. The rate at which the account value is converted to periodic payouts is termed a payout rate; insurance companies set payout rates periodically, and the rate depends on the particular rate at the time of annuitization. Many annuity contracts provide that, if the annuitant dies during the accumulation phase, the value of the account is paid to a beneficiary as a death benefit.

In an embodiment, a guaranteed retirement income account is a subaccount in an annuity contract. The terms of the guaranteed retirement income account may be implemented as a rider on an annuity contract, such as a variable annuity contract. The annuity contract and/or the rider may permit the owner to transfer funds from other subaccounts into a guaranteed retirement income account. The owner may also have the right to transfer funds from the guaranteed retirement income account into other subaccounts. The contract may limit the amount or percentage of funds that may be transferred from the guaranteed income account into other subaccounts on a periodic basis, such as an annual basis. The contract owner may provide for allocation of contributions after the initial premium by percentage among subaccounts, including the guaranteed retirement income account.

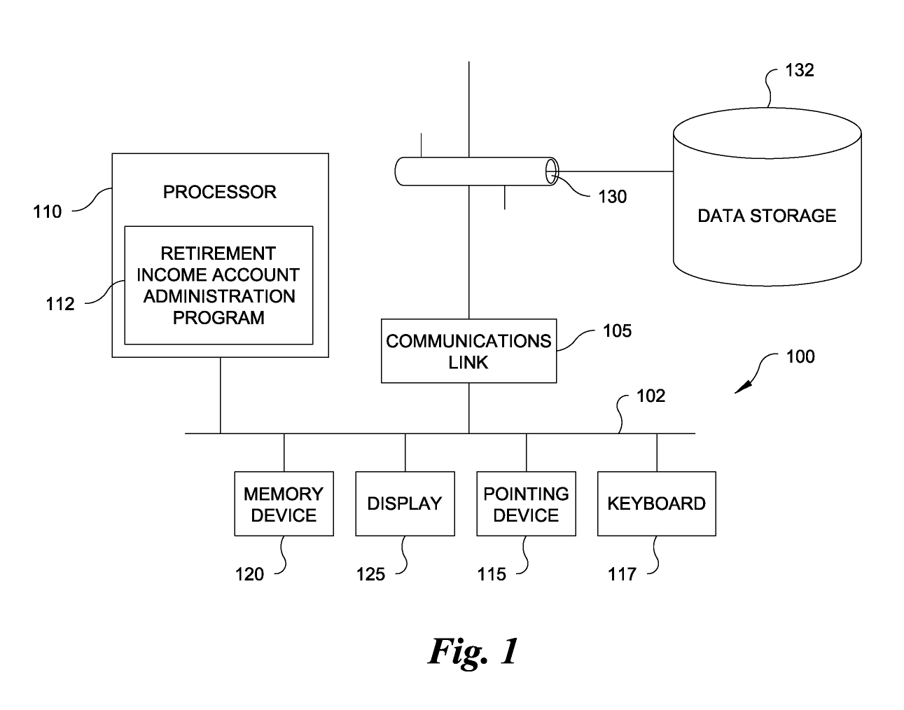

Referring to FIG. 1, an exemplary computer system 100 for use in an implementation of the invention will now be described. In computer system 100, processor 110 executes instructions contained in programs such as retirement income account administration program 112. Computer system 100 may server as an administration module. Programs may be stored on suitable media, such as optical or magnetic disks, fixed disks with magnetic storage (hard drives), tapes accessed by tape drives, and other storage media. Processor 110 communicates, such as through bus 102 and/or other data channels, with communications link 105 and memory device 120, receives data from user inputs such as pointing device 115 and keyboard 117, and provides data to outputs, such as data to video drivers for formatting on display 125. Memory device 120 is configured to exchange data with processor 110, and may store programs containing processor-executable instructions, and values of variables for use by such programs. Memory device 120 may have stored therein account data such as premium amounts, balance value, credited rates, target date ranges and payout rates. In an embodiment, inputs may include user interfaces, including workstations having keyboards, touch screens, pointing devices such as mice, or other user input devices, connected via networked communications to processor 110. Outputs may include displays and printers. Communications link 105 may communicate with remote sources of information, and with systems for implementing instructions output by processor 110, via LAN 130. LAN 130 is merely exemplary, and communication may be by one or more of suitable communication methods, including over wired or wireless local area networks and wide area networks, and over communications between networks, including over the Internet. Any suitable data and communication protocols may be employed. Data storage 132, which may include a wide variety of data acquired and processed in accordance with embodiments, is accessed via LAN 130. Data storage 132 may include data concerning annuity accounts, retirement income subaccounts, contract owners, annuitants, target dates and ranges, payout rates and other data.

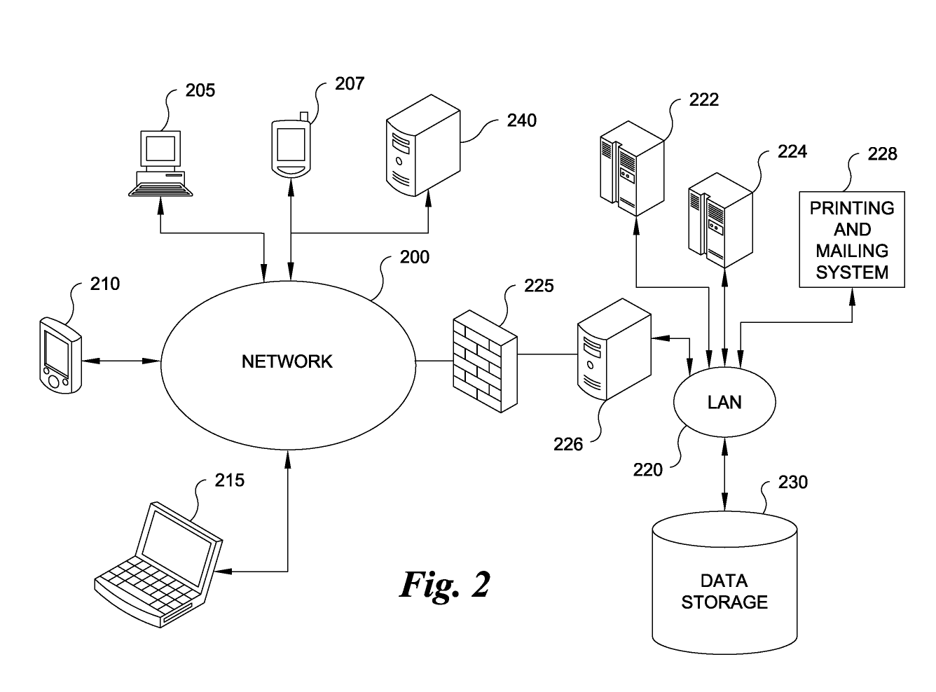

Referring now to FIG. 2, a schematic diagram of a network arrangement including a client server arrangement for implementation of a method and system in accordance with an embodiment of the invention is presented. In the arrangement of FIG. 2, client devices 205, 210, 215 may be connected via network 200 to server 226. In an implementation, client devices 205, 210, 215 may be personal computers running an operating system such as Windows XP, Windows Vista, or Apple Tiger, thin client devices, portable handheld devices such as personal digital assistants (running the Palm OS, by way of example), cell phones, including web-enabled smart phones, or other devices. Software running on client devices may include general purpose browser software, applications software specific to annuity calculation, such as application software for smart phones, and other software. Client devices may be operated by insurance agents or brokers, or by individual account owners, annuitants, financial advisors, or by personnel of an insurance or financial services provider. Network 200 may be or include the Internet, a corporate intranet, wireless and wired communications channels, and other network features. Firewall unit 225 may be configured to provide data security services with respect to systems and networks, including exemplary server 226 and LAN 220. Firewall unit 225 may include distinct hardware, including a processor and memory device, to provide virus protection and user authentication services, for example. In an embodiment, the devices protected by firewall unit 225 may be systems of an insurance carrier. Server 226 may have a processor that is configured or configurable to receive data, such as data applicable to retirement income accounts. Server 226 may receive requests to generate contracts and other documents, and may pass those requests, such as via LAN 220, to another computer system, such as mainframe system 222, which may be based on the IBM/360 platform. Mainframe system 222 may in response to a request and suitable data generate appropriate documents, such as annuity contracts and riders, which may then be passed in electronic format via LAN 220 to printing and mailing system 228. Printing and mailing system 228 may print and mail documents provided by mainframe system 222, or print and mail illustrations furnished by server 226, among other examples. In an embodiment, contracts and related documents may be transmitted in electronic form to a client system, such as a client system in a broker s office, for printing and delivery to an account owner. Server 226 may run various programs that serve to initiate and monitor sessions with one more of client devices 205, 206, 207. Server 226 may serve for display on client devices 205, 210, 215, prompts to the user for data required to prepare illustrations of retirement accounts and to prepare annuity contracts with riders.

Server 226 may implement instructions in programs that provide a web front end, linked to back end computer systems for implementing administration of retirement accounts, as well as administration of annuity accounts having retirement subaccounts. For example, mainframe 224 may include programs for administration of annuity accounts and subaccounts. Data storage 230 may include data received in applications to set up annuity accounts, with retirement savings subaccounts, including data regarding annuitants, beneficiaries, contract owners, initial premium amounts and target payout dates. Server 226 may, by way of example, provide a user with options to obtain information regarding a retirement account, such as current balances, payout ratios, payout amounts, target payout date, payout range, guaranteed credited rates, and contract owner contact information, and be configured to receive signals from user device 205, 210, 215 requesting such information, and to communicate such information to back end systems such as mainframe 224 and data storage 230 via LAN 220. Server 226 may in response to a request from a client device, access and serve for display on the client device illustrations of annuities and annuity subaccounts, data relating to an annuity contract, electronic forms permitting a user to take actions such as selecting an annuitization date, and other data and documents.

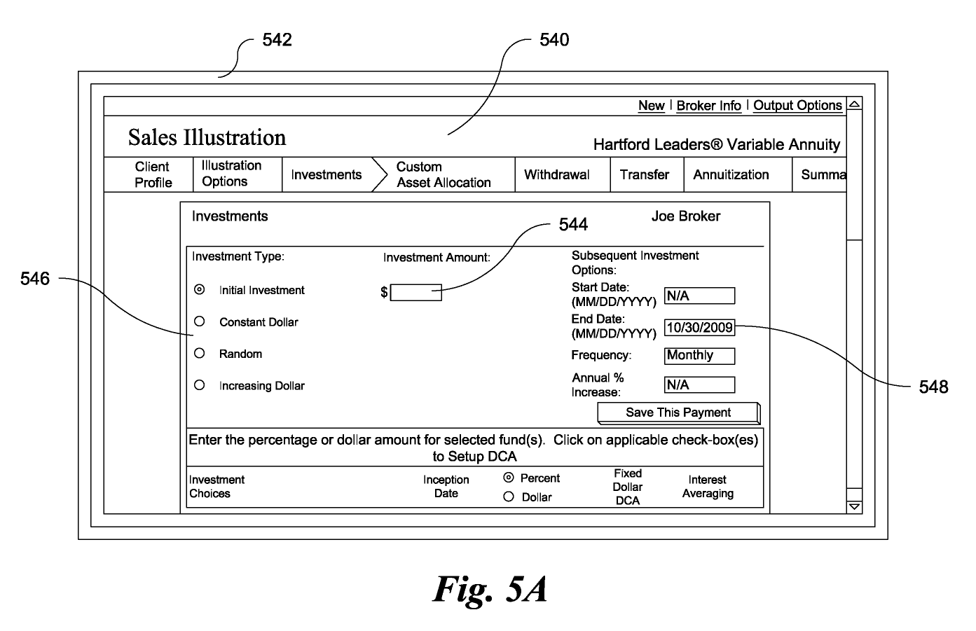

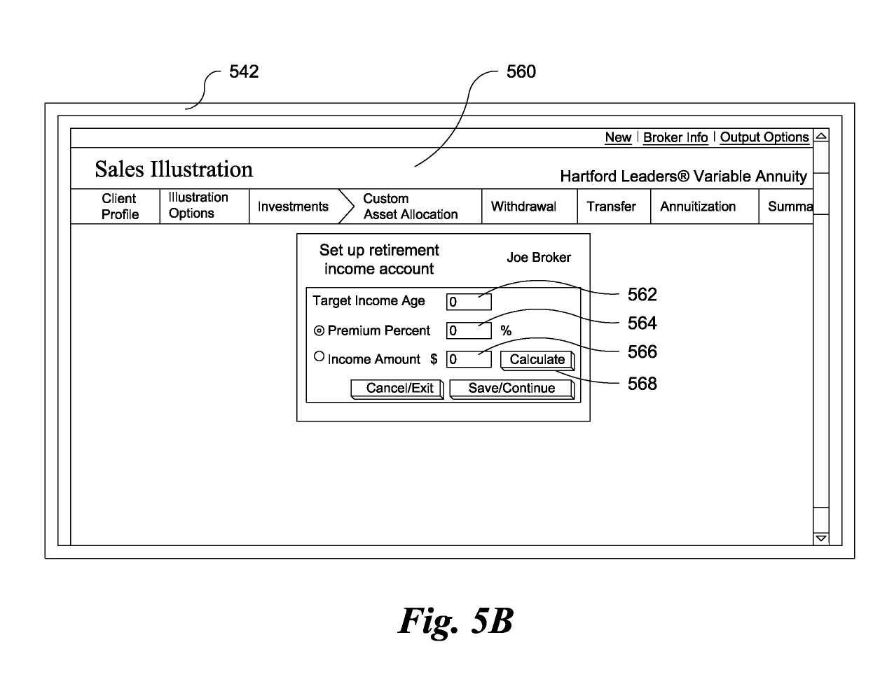

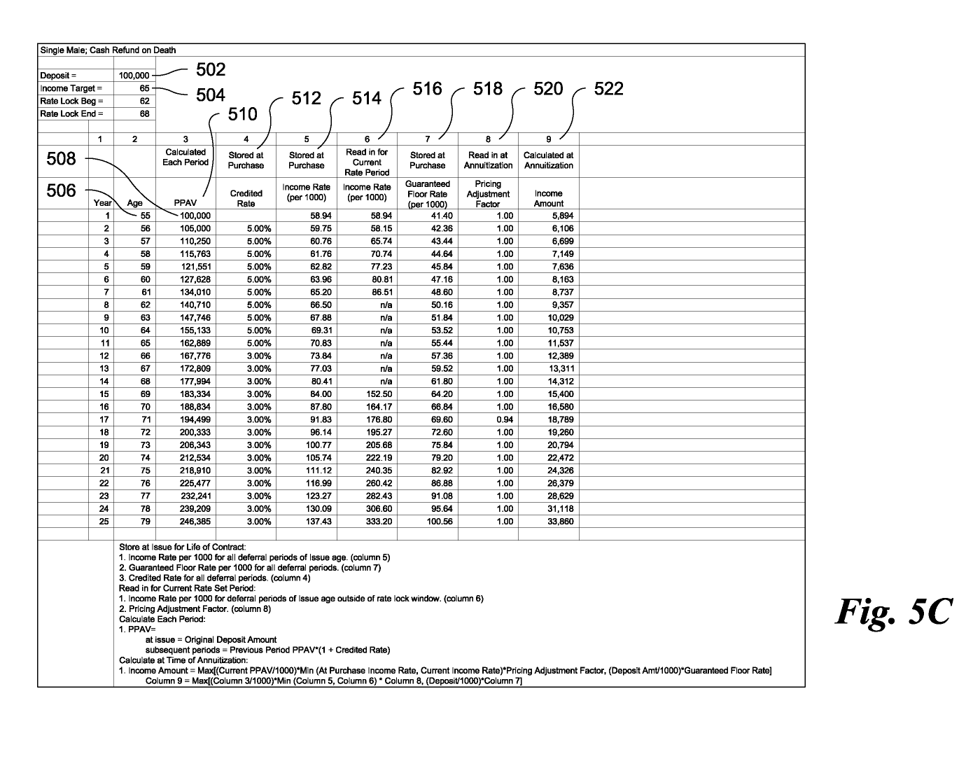

Referring to FIG. 5A, a screen display 540 presented by an illustration tool is shown. The illustration tool may run on a server and be displayed on a client device 542, or may be implemented in a local application, such as a smart phone application program. Display 540 permits a user to select an investment amount 544, an investment type 546 and later investment amounts and frequency 548. The user can thereby input data into the system based on assumptions about a retirement savings program with regular investments. The investments may be, for example, monthly or annual, and may be level or increasing assuming inflation and increases in salary income. Data input into display 540 is saved by a local application or transmitted to a server side application for use in the illustration. Further display 560, shown in FIG. 5B, permits a user to select target start age 562 for the start of income, and either a percentage 564 of the premium to be allocated to the retirement income account or a desired income amount 566. The system will then, in response to the calculate 568 input from the user, calculate the other the percentage or the desired income amount. An exemplary detailed illustration is presented below as a spreadsheet in FIG. 5C.

Server 226 may also access third party systems, such as server 240. Server 240 may be a system of a third party, such as a financial institution that maintains accounts that are employed for payments to or from a contract owner or payments to an annuitant.

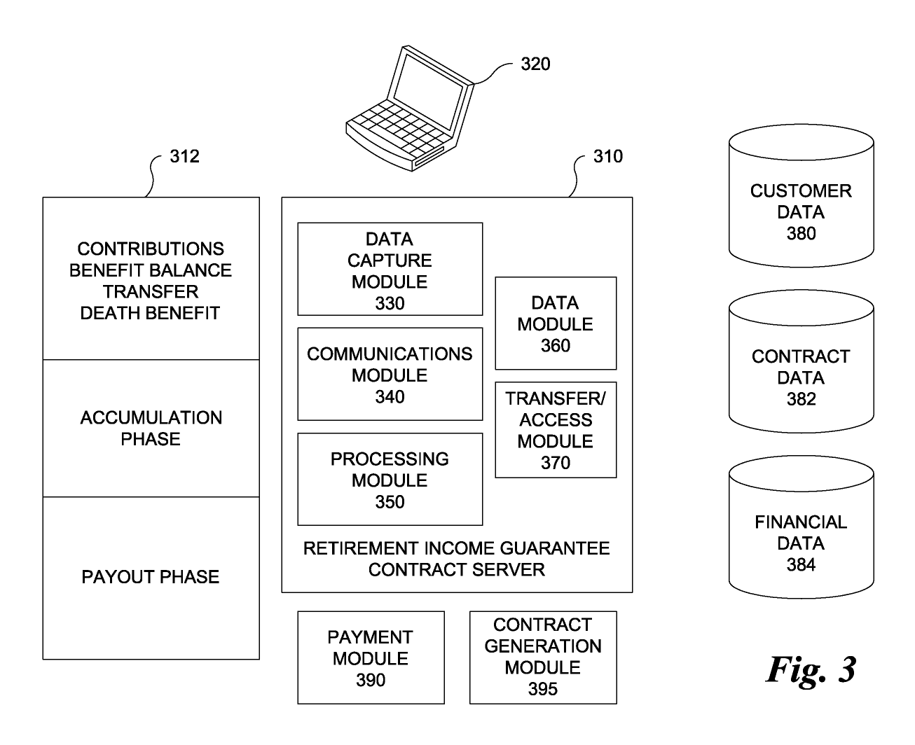

Referring to FIG. 3, an exemplary system 300 implementing a specialized computer server 310 for the administration of one or more retirement income guarantee contracts, and particularly retirement income guarantee accounts 312, is shown. Although a single server is shown in FIG. 3, any number of servers may be included in the system 300. Similarly, any number of devices (and any other devices described herein) may be included according to embodiments of the present invention.

Server 310 may comprise one or more servers adapted to receive, store, process and/or transmit information related to retirement income guarantee accounts, illustrations of such accounts, and other account related data. In various embodiments, server 310 encompasses one or more Web servers which may be accessible to the client devices 320 via the Internet. Web server may be a computer system which includes specialized software for delivering (serving) Web pages to Web browsers running on one or more client devices. In other embodiments server 310 may encompass multiple interconnected servers. More specifically, a software infrastructure may be provided that represents multiple interconnected physical and/or virtual servers as a single logical server. The single logical servers are dynamically allocated to the multiple virtual servers. Each of these virtual servers includes an operating system and a virtual machine. Server 310 may include one or more of a data capture module 330, a communications module 340, an administration module 350, a data module 360 and a transfer/access module 370 for managing and administering a retirement income guarantee account of the present invention. A data capture module 330 may serve to receive data from client devices and make data accessible for other modules. Communications module 340 may serve to provide communications via various protocols between server 310 and other systems and devices. Processing module 350 may serve as an administration module, and may include modules for performing various administrative functions. Data module 360 may serve to perform data maintenance and verification functions. Transfer/access module 370 may serve to permit, subject to suitable verification, user access to data, and to permit upload and download of data. Server 310 may be in further communication with or coupled to a datastore. The datastore may include one or more data sources such as one or more customer database(s) 380, contract database(s) 382 and financial database(s) 384. Customer database 380 may include information regarding individuals and entities that are account owners, annuitants, beneficiaries and others related to annuity accounts. Contract databases 382 may include data relating to the contracts, as well as data relating to current and projected payout rates and credited interest rates. Financial database 384 may include data related to various financial information, such as interest rate information. Each module of server 310 may have read and write access to databases 380, 382, 384 in the datastore, such that data updated or stored by one of the modules is accessible to each of the other modules. As shown in FIG. 3, in the present invention, one or more of modules may also be utilized to perform one or more steps or functions of the present invention. For example, a retirement income guarantee contract account administration module may be implemented as an intelligent hardware component incorporating circuitry comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of computer processors. A module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, comprise the module and achieve the stated purpose for the module such as initiating a retirement income security account. In the present invention a module of executable code may be a compilation of many instructions, and may even be distributed over several different code partitions or segments, among different programs, and across several devices. Similarly, contract, beneficiary and owner and related information may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on an annuity administration system and/or network as shown and describe herein.

Communications module 340 may receive information relating to retirement income guarantee account 312, as will be explained. Contributions are sums allocated to the retirement income security account deposit of premiums, transfers from other annuity subaccounts, or any other permitted method. The benefit balance is the accumulation balance plus any annuity payout value. The accumulation balance is the balance of the account subject to accumulation by application of credited interest rates. The payout value is the amount of the account selected for payout, less the sum of all payouts from the initial payout value. A transfer is a transfer of (i) contract value from an account, such as another subaccount of an annuity, to the accumulation balance, or (ii) the accumulation balance to an other subaccount. The death benefit is, at any time before the annuity commencement date, including during any payout prior to the annuity commencement date, the benefit balance. Contract owners or beneficiaries may receive the benefit amount by transfer, up to the maximum permitted percentage in a year, to another subaccount, electing to receive payouts, commutation of the payouts, or payment of the death benefit.

During the accumulation phase, the account has an accumulation balance. The accumulation balance is the sum of all contributions increased by credited interest; minus any transfers into any other account(s). The accumulation balance converts into annuity payout value(s) based on payout rates on or after the payout commencement date. The credited interest rate is the interest rate that the insurance company agrees to pay periodically on the accumulation balance during the accumulation phase. There may be limits on the amounts of transfers to other subaccounts. For example, the maximum amount that a contract owner may transfer to another subaccount during a contract year (typically the year period between anniversaries of the annuity account) may be the highest of: (a) a specified percentage, such as four (4%) percent of the accumulation balance as of the prior contract anniversary; (b) the amount of interest credited to the accumulation balance over the most recent full contract year; or (c) the amount of the accumulation balance transferred to a retirement income security subaccount during the last full contract year. Annuity payout value may not be transferred.

A target income age is a year that corresponds with the age of the measuring life in which payouts are expected to begin as specified (i) in the application or (ii) if later, by the contract owner when an initial contribution is made into the retirement income guarantee account. The target income age may be restricted, such as to no longer than a period of years, such as 20 years, from the initial contribution, or no later than an age of the measuring life, such as age 80. The measuring life may be the life of the contract owner, or the life of another annuitant. For example, the contract owner may be the spouse of the annuitant, and the annuitant will be the measuring life. The payout commencement range may also be referred to as a guarantee window, and is a period, including the target income age, which may be a seven year period beginning three years before and ending three years after the target income age. The guarantee window may be longer or shorter. The periods before and after the target income age may be of different duration, such as two years before and four years after the target income age. The commuted value of the payouts is the present value of the payout(s) associated with the annuity payout value over the remaining guaranteed payout duration calculated using a discount rate determined by the insurance company. Applicable contingent deferred sales charges and government fees may be deducted, if applicable from the commuted value. The guaranteed payout duration is used for purposes of calculating the commuted value of the payouts. The guaranteed payout duration is equal to the applicable annuity payout value(s) divided by the amount of the corresponding payouts.

An annuity payout value is a portion of the account balance, or benefit balance which provides payouts at a payout commencement date selected by the contract owner. When payouts commence, the corresponding portion of the accumulation balance is converted into an annuity payout value. Annuity payout values are reduced by payouts. The contract owner may convert the entire accumulation balance as of a selected payout commencement date into an annuity payout value. The contract owner may convert a specified percentage or dollar value of the accumulation balance into an annuity payout value.

Server 310 is in communication with payment system 390 and contract generation system 395. Payment system 390 generates payments to contract owners, annuitants and beneficiaries, for example. Contract generation system 395 creates and furnishes annuity contracts to contract owners, such as by printing and mailing, creation of an electronic image file of the contract which is delivered via e-mail or made available on a server in response to providing of suitable credentials, such as a user identification and a password.

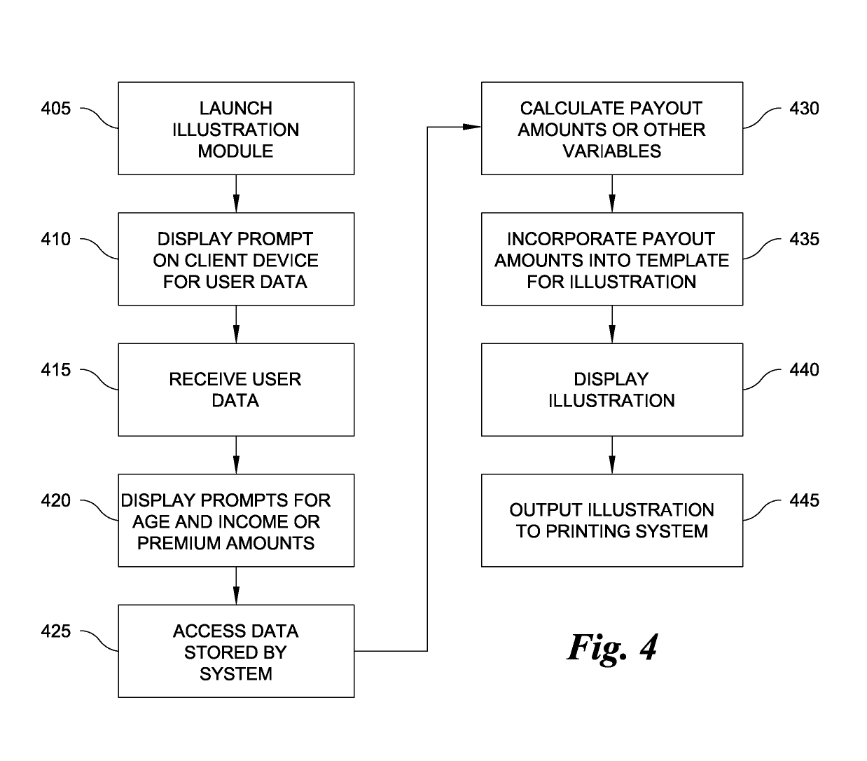

Referring to FIG. 4, a process flow executed by an illustration module of a system in accordance with an embodiment of the invention will be described. In an embodiment, the illustration module may be operating on a web server or other server device. In an embodiment, the illustration module may be implemented as an application having code stored in a memory of a client device, such as client devices 205, 207, 210, 215 of FIG. 2. Upon launch 405 of an illustration module, the module causes a client device to display 410 an initial screen that prompts the user to input data relating to the proposed account owner and other individuals, such as beneficiaries or annuitants, such as name and address information, whether the payout is for a sole annuitant or for joint annuitants, and genders and current ages of the annuitant or joint annuitants. Upon receipt 415 of the user data, the user data may be stored either in a local memory location or in a server location. The illustration module then causes the client device to display a screen prompting 420 the user to provide selected data for determining parameters of a retirement income guarantee product. The prompts may include a desired target age of the annuitant to begin receiving payouts, and one of a premium amount or a desired monthly payout amount. The prompts may also include a prompt for a range of payout commencement dates, such as three years or five years before and after the target payout commencement date.

Upon receipt of the desired payout target commencement age and either a premium amount or desired payout amount, the illustration module may access 425 system stored data necessary for an illustration. The illustration module may use stored formulas, the received variables, and further variables accessed from an administration system, for example, to calculate 430 payout amounts. Tables may be maintained in an accessible database of payout rates and credited interest rates currently offered by the insurance company. In an embodiment, the illustration module may employ formulas expressed in the spreadsheet shown in FIG. 5C, which may be displayed as an illustration to a user on a client device. In the spreadsheet shown in FIG. 5C, the user-supplied data captured from the user is the deposit amount 502, the target age for the commencement of payments 504 and the current annuitant age 506. The inputs here are for a deposit of $100,000 by a 55 year old male, who is both the contract owner and annuitant, with payments targeted to commence at age 65. The deposited amount serves as an initial asset value 508 of the account. Column 510 then shows the benefit balance for each year, assuming that there is no election to convert any of the accumulation balance to payout value balance and start receiving payouts, by crediting interest each year at the rate shown in column 512. The rate shown in column 512 is accessed from memory. The rate shown in column 512 is a credited rate. The insurance company may set credited rates for each a range of years into the future on a periodic basis depending on market conditions. The credited rate is at a first level for a first time period after establishment of the account, and then at a second, lower, level, thereafter. The credited rate may be level for a fixed period, such as ten years, or until a maximum age, such as age 80.

The income rate shown in column 514 is an annual income payment for each $1000 of payout balance, which is the entire or portion of the accumulation balance used as the basis for payouts, at the time payouts commence. The rate is accessed by the illustration module from a system memory location having tables identifying rates by gender, current age, and deferral period. This rate may also be referred to as a payout rate. The payout rate for the target age and the three years before and after the target age is fixed at the time the account is established. The payout rate in column 514 is the guaranteed payout rate within the payout commencement range. Column 516 illustrates exemplary market payout rates; the payout rates in column 516 are not guaranteed. Column 518 illustrates guaranteed minimum payout rates for use in the illustration. The guaranteed minimum payout rates are accessed by the illustration module from a memory storage location of a system. Column 520 illustrates a pricing adjustment factor, which is equal to 1.0 for the target age and within the range. The pricing adjustment factor may be 1.0 or less for other years. The pricing adjustment factor reflects the additional risk taken by the insurer for making payouts available in other years. Column 522 illustrates various annual payout amounts. The value of column 522 may be calculated by the illustration module. The value of column 522 for a year in the target window may be equal to the current asset value of the account divided by 1000, multiplied by the guaranteed payout rate. The value of column 522 for a year outside the target window may be equal to a higher of the current asset value of the account divided by 1000, multiplied by the then-current payout ratio, or the initial deposit divided by 1000 multiplied by the payout ratio.

In an embodiment, the illustration module may receive the payout amount, and provide as an output the deposit amount necessary to reach the payout amount. The illustration module may also receive the payout amount and the amount to be deposited, and then calculate the necessary age at annuitization. Once the calculations have been performed, the results may be incorporated in an illustration template 435 and furnished 440 to the client device for display. The illustration module may also provide for other calculations. For example, the illustration module may permit the user to select an initial lump sum payment followed by periodic payments, with amounts and term of the periodic payments selected by the user; the illustration module may then calculate and display payout amounts. Alternatively, the illustration module may permit the user to select an initial lump sum payment and a desired payout amount, and then calculate and display periodic payment amounts and term required to achieve the desired payout amount.

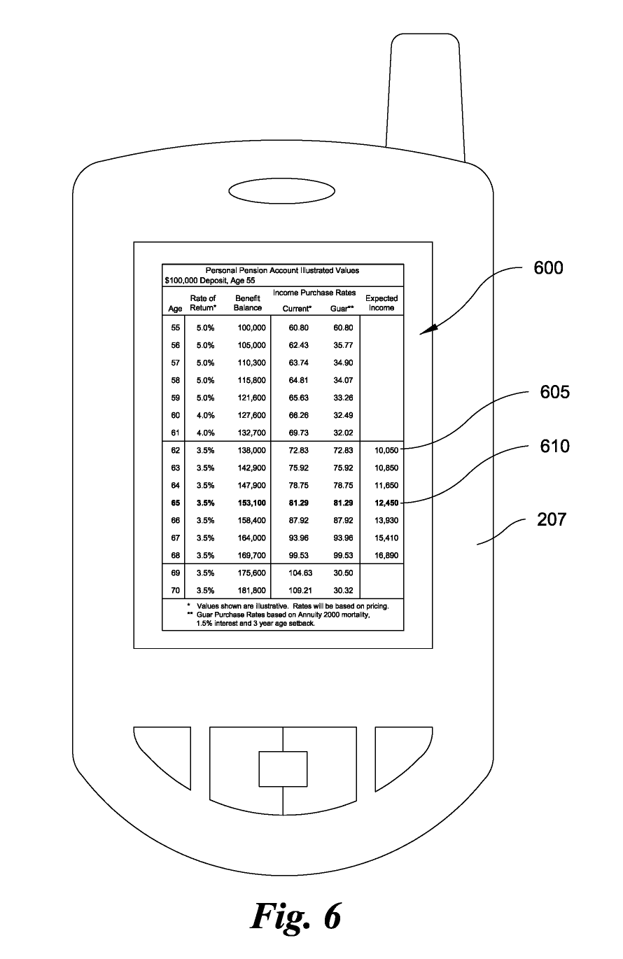

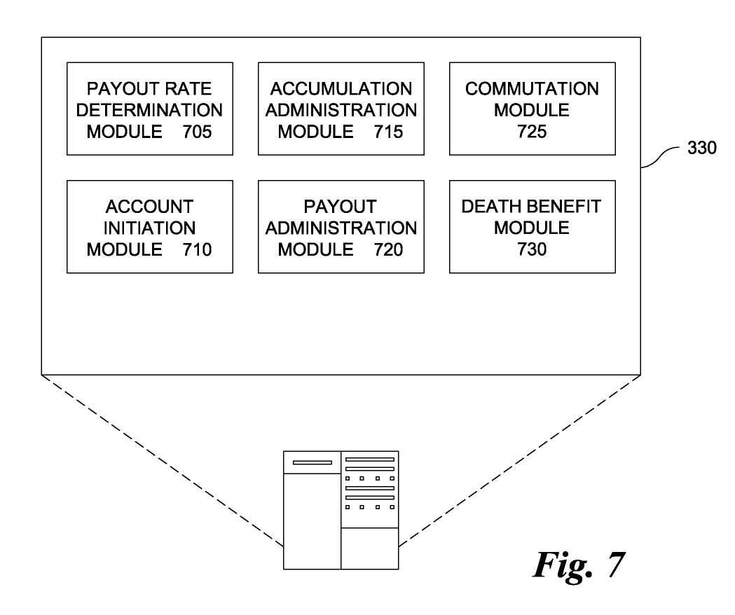

An exemplary illustration is shown at FIG. 6. In FIG. 6, smart phone 207 displays illustration 600. Band 605 represents the range of years around the target payout commencement date for which the payout rate is fixed at the time of the initial premium payment. A payout commencement date may be a period of time, such as a year during which a measuring life reaches a particular age, or a calendar year, or a particular date. Line 610 of illustration 600 shows the target payout commencement date. The customer can readily see the fixed payout amounts and appreciate the flexibility associated with a system of the invention. The illustration module may output 445 the illustration incorporated in the template to a printing system, along with user address data, for printing and mailing to the user.

An annuity administration system processing module 350 may have further modules that perform various functions associated with the annuity. Annuity administration system processing module 350 may include payout rate determination module 705, account initiation module 710, accumulation administration module 715, annuitization module 720, commutation module 725 and death benefit module 730. In other embodiments, additional modules may be provided to provide for additional functionality.

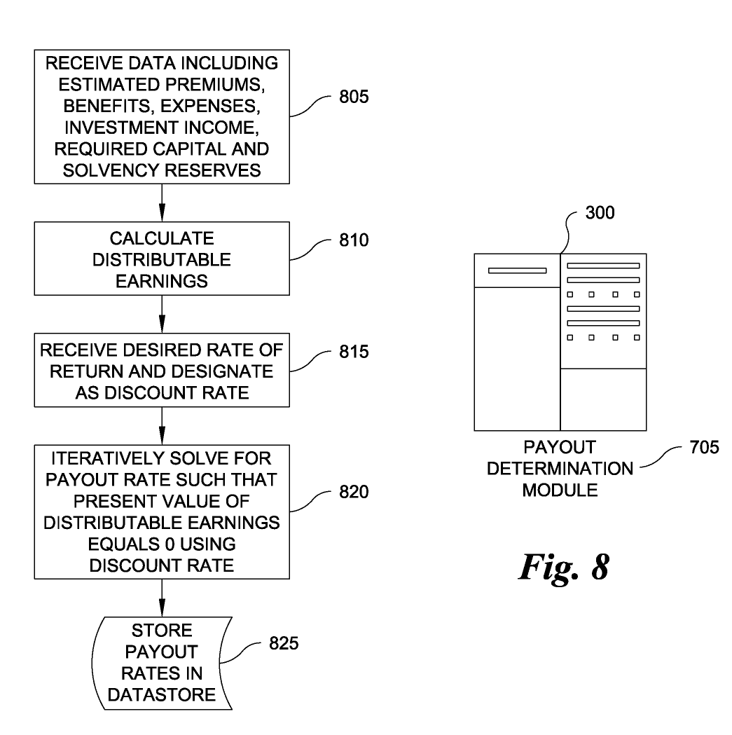

Payout rate determination module 705 may execute processes that will be explained with reference to the process flow illustrated in FIG. 8. Payout rate determination module 705 may retrieve appropriate formulas and variables to solve for an income rate that provides a desired rate of return. Module 705 may iteratively solve for a payout rate that meets the requirement that the present value of distributable earnings (PVDE), using a discount rate equal to the desired rate of return where the current period PVDE is positive, and equal to the rate to borrow when the current period PVDE is negative. Distributable earnings are earnings of an insurance enterprise that can be distributed to the owners of the enterprise, such as shareholders, taking into account cash flow requirements, solvency reserves, and required capital. Negative distributable earnings represent an amount that the owners must contribute to the enterprise in order for the enterprise to be considered solvent.

In order to determine the distributable earnings applicable, the payout rate determination module calculates the distributable earnings as: (a) product cash flow, defined as premiums less benefits and expenses associated with the annuity; plus (b) investment income, less (c) expenses and fees associated with investments and less (d) increase in reserves and required capital. The formula used by the module to determine the distributable earnings (DistEarn) for a year t may be:

DistEarn(t)=AfterExpenseSolvEarn(t)ReqCapIncr(t)+ATInvIncRC(t)

where AfterExpenseSolvEarn(t) is product cash flow, and may be calculated as:

AfterExpenseSolvEarn(t)=PreExpenseSolvEarn(t)Expense(t)

where Expense(t) are applicable expenses and fees associated with investments, and PreExpenseSolvEarn(t) are net cash flow prior to consideration of expenses and may be calculated as:

PreExpenseSolvEarn(t)=ProdCashFlow(t)+InvIncome(t)SolvResIncr(t)

where ProdCashFlow(t) is the product cash flow, InvIncome(t) is the investment income, and SolvResIncr(t) is an increase in required solvency reserves from the prior year (year t−1) to year t. The increase in solvency reserves from year t−1 to year t may be represented as:

SolvResIncr(t)=SolvRes(t)SolvRes(t−1)

Product cash flow in year t may be represented as:

ProdCashFlow(t)=Prem(t)Ben(t)Exp(t)

As noted above, product cash flow is premiums (Prem(t)), less benefits (Ben(t)) and less expenses (Exp(t)).

The required capital increase term in the equation for distributable earnings is simply the increase in required capital from the prior year (ReqCap(t−1)) to the current year (ReqCap(t)),

ReqCapIncr(t)=ReqCap(t)ReqCap(t−1)

The after expense investment income may be represented as:

AEInvIncRC(t)=InvIncRC(t)ExpInvIncRC(t)

where the term InvIncRC(t) represents estimated investment income, and the term ExpInvIncRC(t) represents estimated expenses associated with the estimated investment income.

In estimating the values above, various well known assumptions from the insurance industry may be used. Current mortality rates and estimated future mortality improvement are preferably considered, taking into account experience and valuation level. The model office assumptions, considering age, premium, gender, deferral period, number of policies, and benefit payment frequency, may be employed. Applicable statutory valuation interest rates may be employed. Initial investment rate of return, reinvestment rate of return, and rate earned surplus may be considered. The credited rate schedule associated with the annuity contracts may be considered. Commissions may be considered, including commissions associated with initial payment and trail commissions. Initial and continuing or renewal expenses, both fixed as to dollar amount and as a percent of premium, account value, accumulation balance or benefit balance may be considered. Applicable expenses, including expenses required under applicable government regulation, may be considered. Required capital may be considered.

Referring to FIG. 8, the payout rate determination module 705 of server 300 may execute the following process flow. Data points necessary to perform the above-identified calculations, including estimates of premium amounts, benefit amounts, expenses, solvency requirement data, investment returns, expense estimates, capital requirements, and other data, may be received 805. These data points may be input from a client device and received via communications module, may be accessed from memory, or received in other suitable manners. The distributable earnings for each year may then be determined 810 by a processor executing calculations embodied in formulas such as those set forth above. A desired rate of return is received 815 and may be designated a discount rate. A processor may iteratively solve for 820 the payout rates at which the present value of distributable earnings is zero, given the desired return as the discount rate. The resulting payout rates for each year may then be caused to be stored 825 in a datastore. The payout rates may then be accessible to other modules, including, by way of example, an illustration module and an account initiation module.

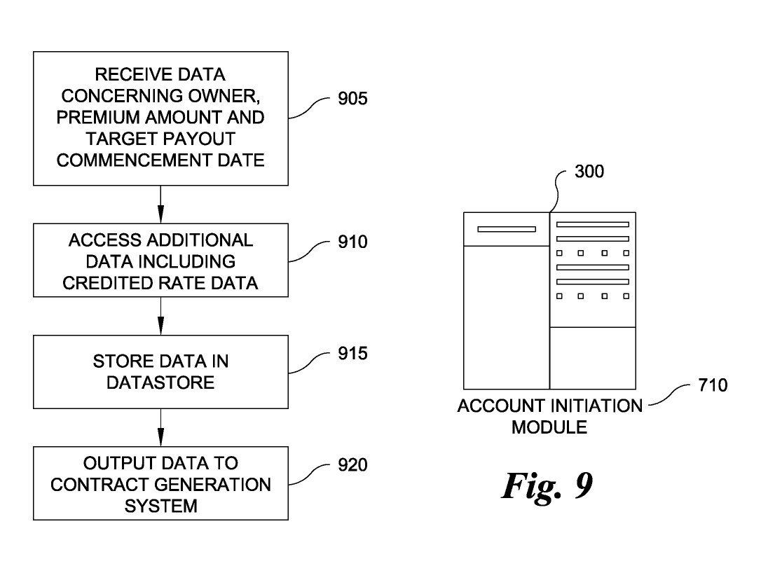

Referring to FIG. 9, a process flow diagram illustrating steps taken by a account initiation module 710 are shown. Account initiation module receives, such as via communications module 340 (of FIG. 3), data including: name and address of account owner, age and gender of the account owner and/or annuitant or, if there are joint owners, both of the owners, initial premium amount and target age or target date of payout commencement. Options and riders that may be selected at the time of account commencement must be received at that time. For example, data indicative of riders and options such as an annual benefit increase rider, and an amount of the increase or an index from which the increase amount is determined may be received. Death benefit options, such as a return of premium death benefit option, may be received.

Upon receipt of the data, the account initiation module accesses 910 additional data, such as data indicating rates at which interest will be credited to the accumulation balance, and data concerning charges applicable to the account. The account initiation module may run business rules to determine if the received and accessed data is complete and accurate. For example, the rules may require that the target payout commencement date be at least ten years in the future; a business rule may determine if the current age of the measuring life and the target age for commencement of payouts are at least ten years different. If the received and accessed data is not complete and accurate according to the business rules, an output signal may be provided to the communications module indicative of the discrepancy; responsive to the output signal, the communications module may prepare a communication, in the form of text on a screen display for display on a client device, an e-mail, an automated telephone communication, or a printed and mailed letter, to an account owner or broker. The account initiation module may store the status of the account as awaiting additional information, and cease processing that account. If the received and accessed data passes the business rules, the account initiation module may store 915 data in a datastore accessible to other modules. The account initiation module may also output 920 a signal having data indicative of instructions for a contract generation system or contract generation module to generate a contract consistent with the data provided by the account initiation module. The contract generation module may furnish the generated contract by printing and mailing, by fax transmission to the contract owner, or by generating an image file and making the image file available to the contract owner, such as by e-mail or by providing a secure link or credentials to access the account at a server.

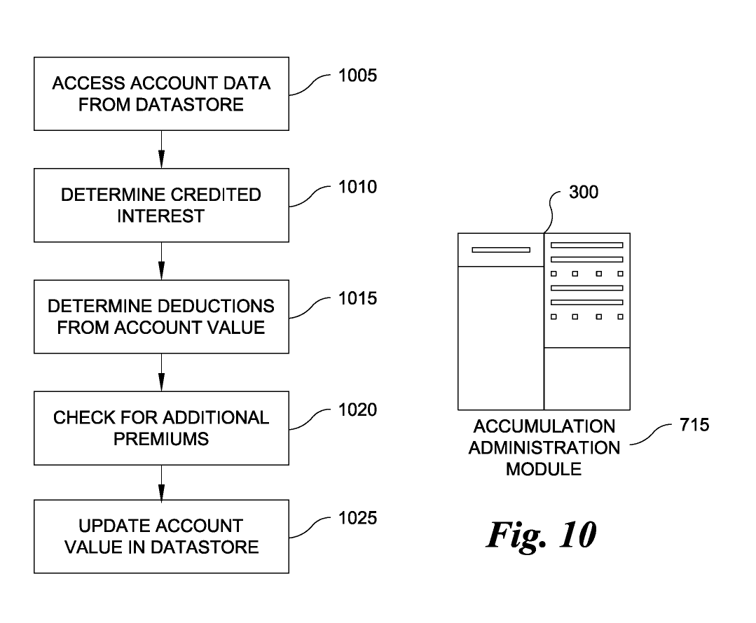

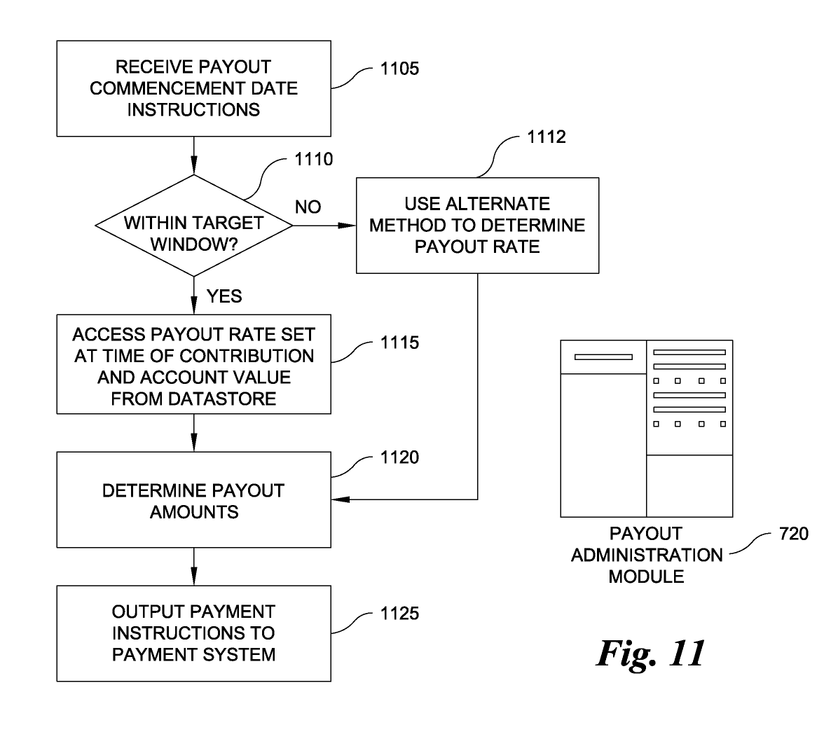

The accumulation administration module 715 may perform functions for administration of the account during an accumulation phase. The accumulation phase of the account is the time from initiation of the account until the entire accumulation balance is converted to payout value, or the entire accumulation balance is redeemed, or the death benefit is paid. During the accumulation phase, the accumulation administration module 715 periodically, as indicated in FIG. 10, accesses 1005 account data, calculates credited interest 1010, calculates charges 1015, checks an appropriate memory location for an amount and credit date of later premiums 1020, and updates the accumulation balance in a datastore. The updated accumulation balance is then available to other modules. The process may be carried out on a daily basis. The accumulation administration module may also provide an output signal to a printing and mailing system to provide reports of accumulation balance, credits and charges.

Payout administration module 720 may be invoked on receipt of data indicative of an instruction to convert all or a portion of the accumulation balance to a payout value and start receiving payouts. Module 720 receives payout instructions 1105 via communications module 340. Payout instructions may include account identification information, a payout commencement date (which may be permitted to be only a relatively brief period, such as 90 days, after the instructions), whether the entire accumulation balance is to be used for the payout, and, if not, an amount of an accumulation balance to be employed for payouts. Payout instructions may be generated, by way of example, in response to a contract owner or a contract owner s representative providing instructions on paper, or electronic instructions via web interface or client-device based application to employ for payouts all or a portion of the accumulation balance. In an embodiment, the payout administration module may also determine if a date for mandatory payouts has been reached; in an embodiment, a date for mandatory payouts may be the later of an anniversary of the account, such as the 10^{th} anniversary, and certain age of the annuitant, such as age 90. The process flow then proceeds in the same manner as if instructions for use of the entire accumulation balance for payouts had been received. The payout administration module determines 1110 whether the payout commencement date is within the payout commencement range. If the date is within the range, then the payout administration module accesses 1115 the payout rate corresponding to the date, and the accumulation balance, from a datastore. The payout rate was stored in the datastore by account initiation module at the initiation of the account. The current accumulation balance was stored in the datastore by the accumulation module. Employing the entire accumulation balance, or a portion of the accumulation balance, which may be termed a payout balance, to be used for payouts, the payout amounts are determined 1120. The payout administration module obtains annuitant information, such as address and payment preferences, such as bank accounts, from the datastore. Instructions for payment are output 1125 to a payment system. Instructions for payment include amount, date, payee, manner of payment, and other required information. The payment system may provide for printing and mailing of suitable paper checks, or providing of paper or electronic instructions to the payor s bank to effect an electronic transfer of funds to the payee s designated bank account.

If the payout commencement date is not within the range, then an alternate method may be employed 1112 to determine a payout rate. In an embodiment, the following procedure may be used. If the payment commencement date is prior to the target range, the module projects the accumulation balance, the annuity payout value and the income payments assuming income is taken starting at the target age.

The projected account value, or accumulation balance, may be represented as:

Accumulation_Balanceₛ=Accumulation_balanceₜ₋₁*(1+crediting_rate)−Starting_Income_Amt

where the accumulation balance at time t=0 is the initial premium less any applicable charges. The crediting rate is dependent on the deposit date of the initial premium and the duration the funds have been in the account.
The annuity payout value for year t may be expressed as:

Annuity_Payout_Valueₜ=max(Annuity_Payout_Valueₜ₋₁Incomeₜ₋₁,0)

where:
Annuity Payout Value is 0 before the payouts commence. When the payouts commence, the Annuity Payout Value is initially is equal to the lump sum which is converted to income, and then is reduced by the amount of income paid in the prior year, until reduced to 0.
An income payment amount is equal to the rate multiplied by the annuity payout value, divided by a factor, i.e.:

Income_Pmt=Income_Rate*Annuity Payout_Value/1000

The module then calculates the actuarial present value (APV) of the expected payment.

$$A P V = {\sum }_{T} \frac{1}{{( 1 + i )}^{t}} * ( {}_{t}^{}{p}{}_{x}^{} * Income\_Pmt \_ + {}_{t - 1}^{}{p}{}_{x}^{} * {q}_{x + t} * ( AnnuityPayoutValue + AccumulationValue ) )$$

where:

ₜpₓ is the probability that an individual aged x survives to age x+t

qₓ₊ₜ is the probability that an individual aged x+t passes away before age x+t+1

i is the discount rate applied in the present value calculation.

The module then calculations a preliminary income figure:

Preliminary_Income=Current_{—}A−Share_Rate*AVP/1000

where:

Current A-Share is the immediate annuity purchase rates (current age defer 0)

The module then determines a payment amount. This is the maximum of the two following values:
i′ the minimum of
   a′ preliminary income
   b′ maximum payout (at issue amount); and
   ii′ non-forfeiture payments

where:

Non-Forfeiture_Pmt=Non-Forf_Balance*Attained_Age_Min_Rate/1000

Non-Forf_Bal=87.5%*(Prem−Upfront_costs)*(1+i_{NF})^{t}

The revised income rate is determined as:

$$Revised\_Income \_Rate = \frac{Payment\_Amt}{Accumulation\_Balance} * 1000$$

Once the revised income rate has been determined, the module determines 1120 the payout amount, and the process flow continues to output instructions to the payment system 1125.

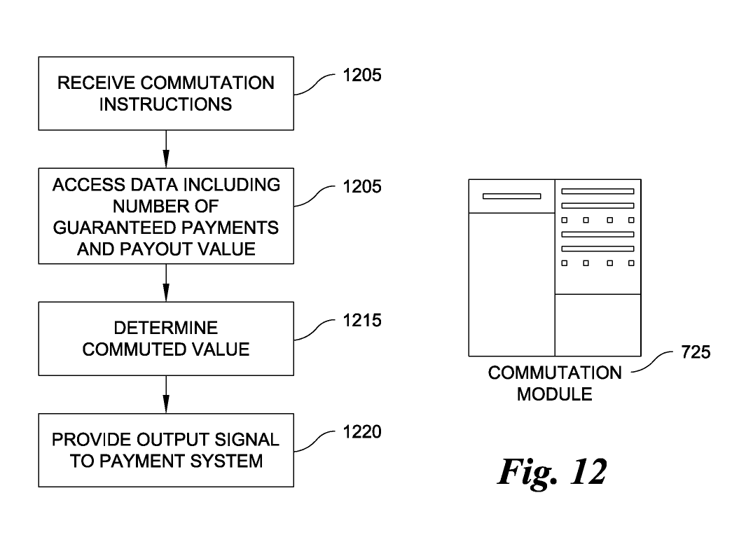

Referring to FIG. 12, a process flow diagram illustrating steps in a method performed by commutation module 725 is shown. Commutation instructions are received 1205. The module accesses 1210 data in the datastore including a number of guaranteed payments and a payout value. A number of guaranteed payments may be a number of payments that would be received notwithstanding the death of the annuitant, and may be a sufficient number to meet a value such as the initial premium deposited or total premiums deposited, or accumulation value at the commencement of payouts. The module may calculate the number of guaranteed payments using the following formula:

$$Number\_of \_Guaranteed \_Payments = \frac{Annuity\_Payout \_Value}{Payment\_Amount}$$

The module then determines the commutation amount by summing the present value of each of the payments, using the formula:

$$Commuted\_Value = {\sum }_{t = 1}^{\# ofGpmts} \frac{Income\_Pmt}{{( 1 + i )}^{t}}$$

The discount rate i is selected by the insurance company.

The module may output 1220 a signal to a payment system with data identifying a payee and a commutation amount.

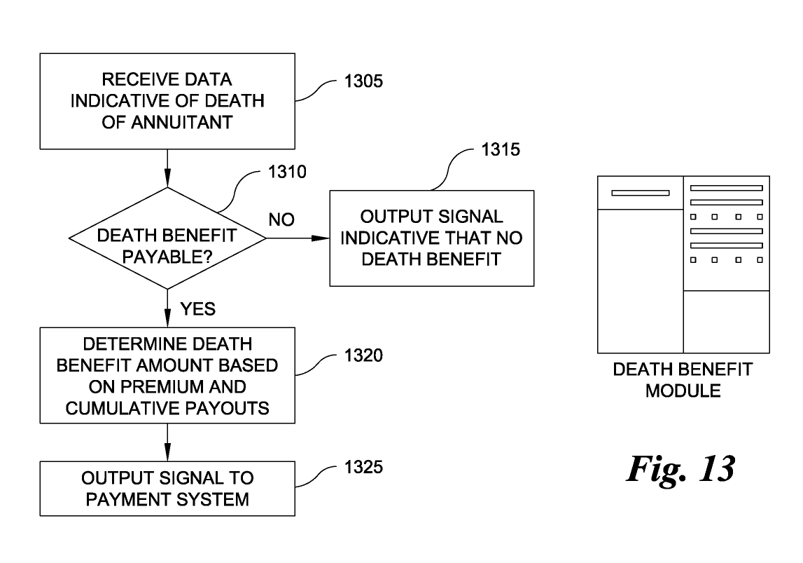

Referring to FIG. 13, a process flow performed by a death benefit module is illustrated. The module receives 1305 data indicative of a death of an annuitant. The module may then determine 1310 whether a death benefit is payable. By way of example, the contract may provide that the death benefit is equal to the benefit balance, which is the accumulation balance plus the payout value. The contract may alternatively provide that the death benefit is equal to premiums paid, less any payouts and redemption amounts. If the module determines that no death benefit is payable, the module outputs 1315 a signal indicative of no death benefit. This signal may be received by a printing and mailing system which is triggered to print and mail a letter to the beneficiary. If a death benefit amount is payable, the system may determine 1320 the amount and output 1325 a signal to a payment system.

In an embodiment, a system may include a commission module. A commission module may, on a periodic basis, access an account value, accumulation balance, benefit balance, or other data, from a memory storage device. The commission module may access formulas and rates for calculating commissions. For example, a formula may be provided for calculation of a commission based on a percentage of a benefit balance on an anniversary of an account. The commission module may determine a commission amount based on the account value, accumulation balance or benefit balance. The commission module may also access data indicative of an identity of a producer, such as an insurance broker, who is entitled to a commission. The commission module may provide an output signal having data indicative of the commission amount and the identity of the producer to a payment system for payment of the determined commission amount.

In an embodiment, an administration system may, on a periodic basis, determine credited interest and update the accumulation balance. The system may check for data indicative of a payout request, a death benefit, or a redemption, and continue the account in the absence of receipt of such data without change.

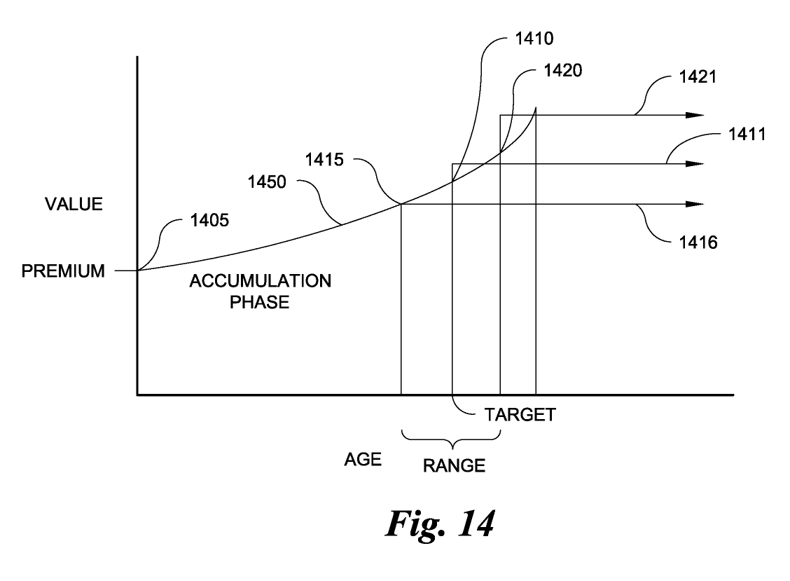

FIG. 14 illustrates value of an account and benefit payments against age. At 1405, an initial premium is received, and the value 1450 of the account grows as interest is credited. At 1415, the payout commencement date range opens. By commencing payments at this time, the annuitant receives a continuing payment 1416. The payout commencement target date 1410 is shown; the continuing payment 1411 is represented as greater than payment 1416, and at a higher ratio of the accumulation balance, as the fixed payout ratio is higher at later periods within the range. The end of the target window 1420 results in a still higher payment 1421 at a still higher ratio of the accumulation balance.

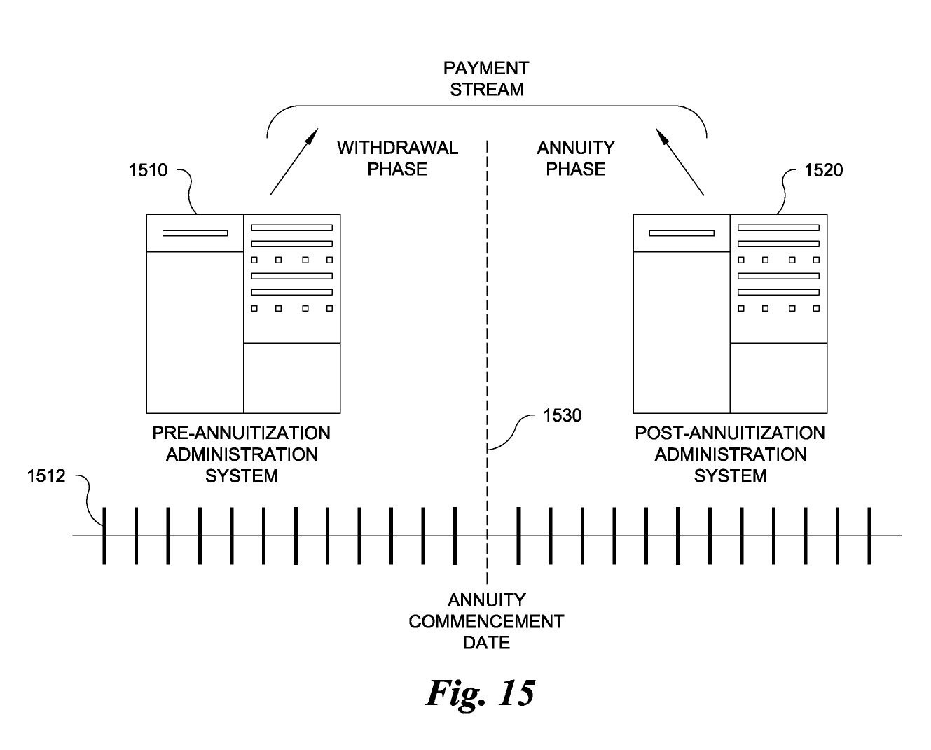

FIG. 15 is a schematic diagram illustrating the use of different computer systems to administer accounts before and after the annuity commencement date. A pre-annuitization computer system 1510 may provide the administrative functions from commencement of an account at 1512 through the annuity commencement date 1530. The administrative functions include application of premiums to subaccounts, such as a guaranteed retirement income account, variable annuity accounts, and other accounts, tracking changes in account value and benefit balance resulting from credited interest, investment returns, and charges, disposition of later premiums, determination of payout amounts, and administration of payouts. At annuity commencement date, the entire account value, including other subaccounts, is annuitized and converted to a payment obligation. There is no further account value, including no further payout value to serve as the basis of a death benefit. Upon annuitization, the guaranteed payout rates are applied to any accumulation balance. Post annuity commencement date, the administration obligations are primarily continuing to provide payments to the annuitant or annuitants. Post-annuitization computer system 1520 provides administrative functions after the annuity commencement date.

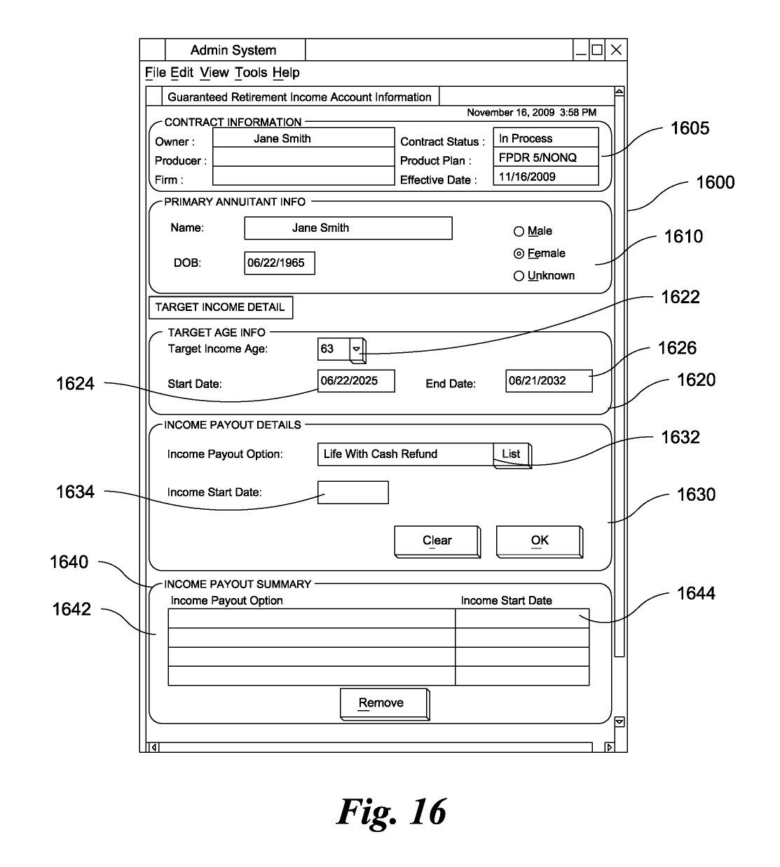

FIG. 16 is a screen shot showing a operation in an account initiation module in the pre-annuitization administration system. The system has presented screen 1600. Screen 1600 displays data captured from a database showing basic contract information in section 1605. Basic contract information may include owner name, producer name, status of the contract, identifying product data, and an effective date. Primary annuitant information is captured from a database and displayed in annuitant section 1610. In this example, the contract owner and the annuitant are the same person. The date of birth and gender of the primary annuitant are shown. The date of birth and gender of the annuitant are sufficient information in an embodiment for determination of the guaranteed payout rates. If there are joint annuitants, the names and dates of birth of both joint annuitants will be displayed. The target age information section 1620 permits the user to enter a target income start date by selecting an age 1622 of the annuitant. In another embodiment, the target income start date may be entered by selecting a calendar date, such as a calendar year. In response to user selection of age 1622 of the annuitant, the system calculates and displays the guaranteed payout range start date 1624 and the guaranteed payout range end date 1626. In this embodiment, a fixed seven year range is calculated. In income payout details area 1630, the user is prompted to select a payout option 1632. A drop down menu may be provided indicative of available options. An option for payouts continuing for the lifetime of the annuitant with a cash refund of premiums paid. Other payout options include a lifetime annuity without a cash refund. Once the contract owner has determined a payout start date, the user may insert the income start date 1634. In income summary payout area 1640, the system displays income payout options 1642 and income start dates 1644 for each of one or more payouts.

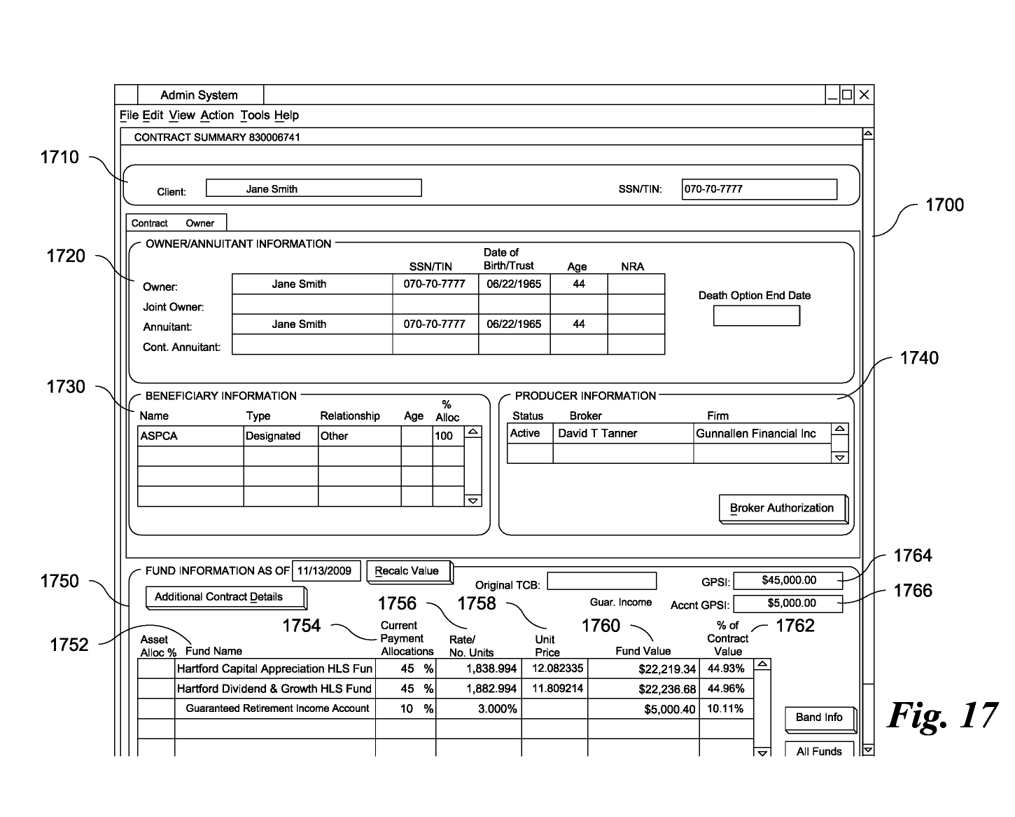

FIG. 17 is a screen shot of a page 1700 generated by a pre-annuitization administration system to provide an overview of an annuity contract that provides a guaranteed income account as one of a number of investment options. The system queries a database to obtain data to populate fields in page 1700. Client summary section 1710 displays a client name and an identifying number or code, such as Social Security number or business identification number. The client name is in most cases the name of the contract owner. Owner/annuitant information section 1720 displays the names of the contract owner, any joint owner, the annuitant and any contingent annuitant, along with identifying numerical information, and the ages of each of those individuals. In this embodiment, the sole owner and the annuitant are the same individual, and there is no contingent annuitant. Beneficiary information section 1730 identifies beneficiaries of the death benefit, the percentages of the death benefit that each beneficiary is to receive, and the relationship of each beneficiary to the contract owner. Producer information section 1740 identifies a broker, agent or other financial advisor. The identified producer may receive copies of certain communications, and may be entitled to commissions based on a percentage of an account balance or a percentage of a net asset value. Fund information section 1750 identifies the allocations of funds within an account to subaccounts. Subaccounts 1752 include variable annuity subaccounts and a guaranteed retirement income subaccount. In this embodiment, an allocation 1754 of current payments into the account among the various subaccounts by percentage is shown. In column 1756, the current number of units of the variable annuity subaccounts are shown; for the guaranteed retirement account, the credited interest rate, which is 3% here, is shown. The price per unit 1758 for the variable annuity subaccounts is shown. The current value of each subaccount 1760 is shown. Column 1762 shows the percentage of the total account value represented by each subaccount. The amount of premium paid allocated to the variable subaccounts is shown at 1764 and the amount of premium paid allocated to the guaranteed income account is shown at 1766.

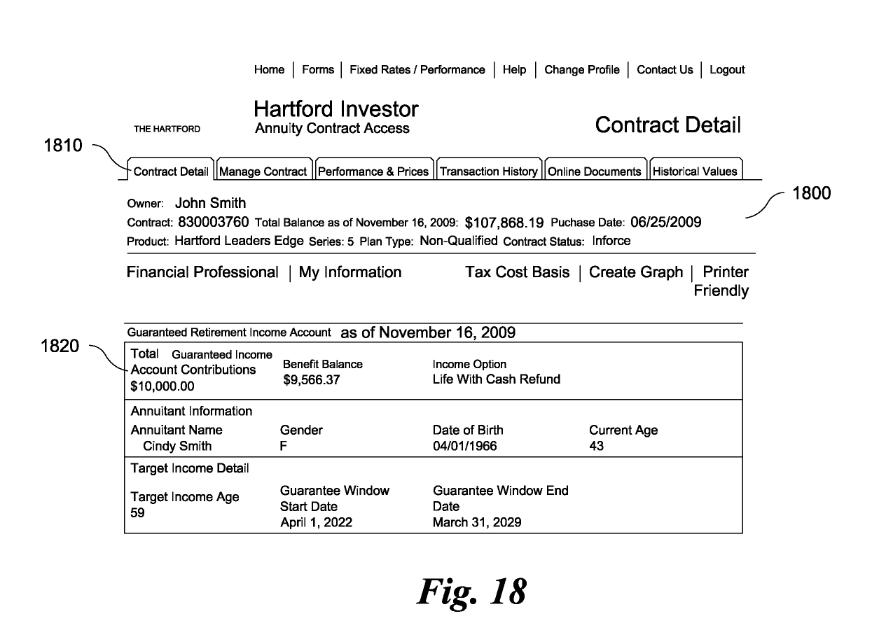

FIG. 18 shows a page 1800 displayed on a user device by a server providing account access services of a summary of an annuity account, with detailed information regarding a guaranteed income account. Summary section 1810 identifies a contract owner, a total balance including all subaccounts, and a contract number. Detail section 1820 provides details regarding a guaranteed income account, including total contributions, the benefit balance, the payout option, the identity of the annuitant along with age and gender information. The target payout start date is shown by age of the annuitant, along with the target payout range beginning and ending dates.

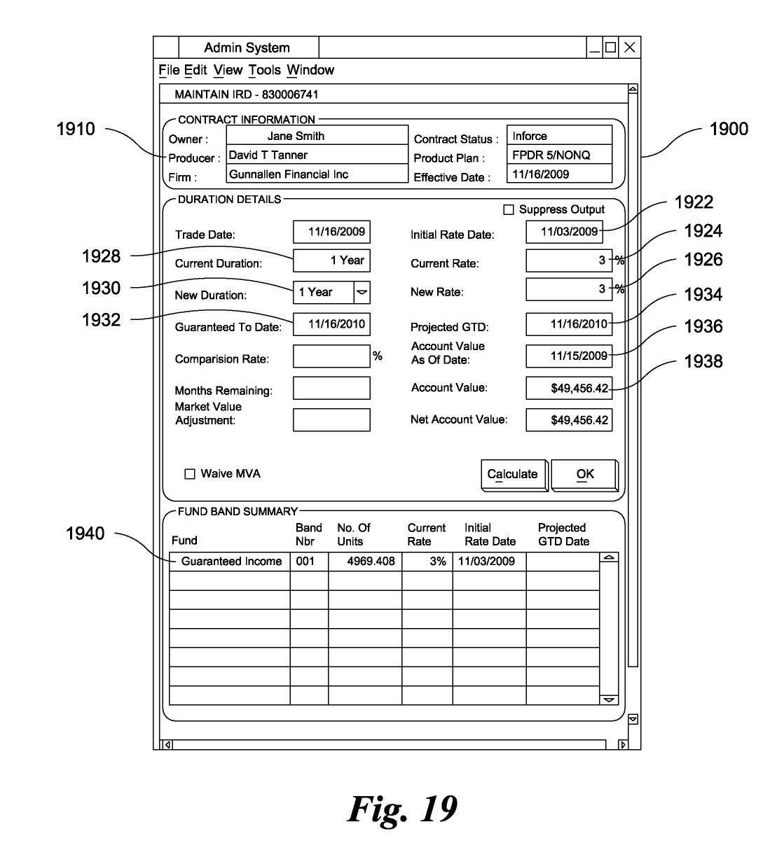

FIG. 19 shows a display on a user device of a system for administration of annuity accounts pre-annuitization permitting a user to select a new credited rate and a duration for the rate. Contract information section 1910 displays general information regarding the annuity contract, including owner name and effective date. Rate information includes an initial rate date 1922, a current rate 1924, and a new rate 1926, with a projected date 1934 to which the new rate is guaranteed. The current date 1936 and the account value 1938 are displayed. A current duration 1928 of the rate, and a new duration 1930 are shown, along with a guaranteed to date 1932 based on the new duration. A summary of applicable funds 1940 is shown, indicating a guaranteed income account assigned to a sole band.

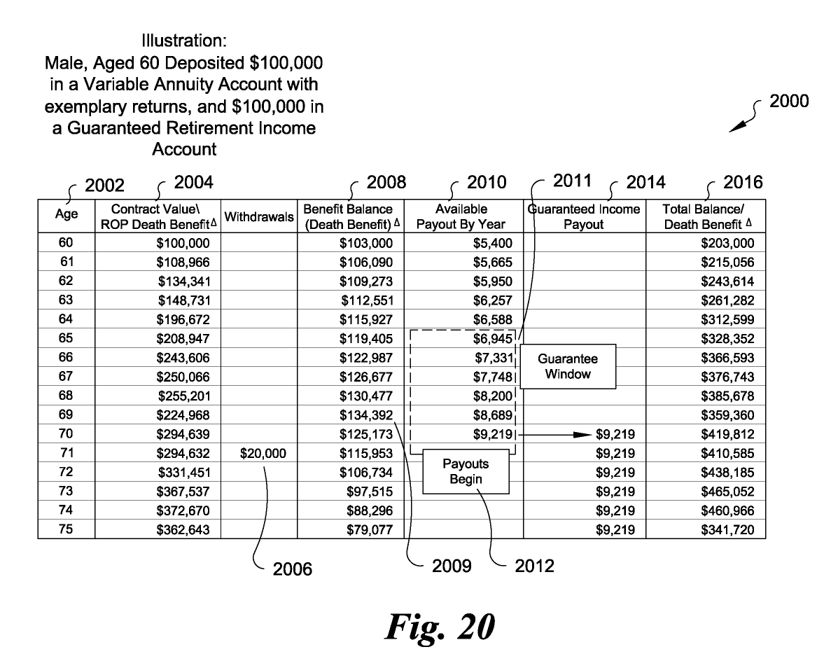

FIG. 20 shows a display, which may be displayed on a user device by an illustration module of a system, of an illustration 2000 of an account. The account is established by a male at age 60 with $100,000 in an investment option and $100,000 in a guaranteed retirement income account, with age 68 selected as the target payout commencement age. Ages are shown in column 2002. The net asset value of the investment account at the end of each year is shown in column 2004. The owner withdrew $20,000 from the investment account at age 71. The withdrawal reduced the net asset value of the investment account, but did not affect the guaranteed retirement income account. In column 2008, the benefit balance of the guaranteed retirement income account is shown. The benefit balance increases by the guaranteed interest rate each year through age 69, as shown at 2009; the payouts are selected to begin at age 70. Column 2010 shows the available payout by year, based on the benefit balance of column 2008 and the payout rate. Until the beginning of the payout commencement date range, the payout rate is based on market rates. During the payout commencement date range 2011, or guarantee window, the payout is based on payout rates fixed at the commencement of the account at age 60. The contract owner selected payouts beginning at age 70, at 2012, after the target payout commencement date, but during the guarantee window. The payouts are shown in column 2014 and are a level $9219 for life. The payouts reduce the benefit balance of column 2008, to which interest is not credited once the payouts begin. Column 2016 shows the total benefit balance, which includes the net asset value of the investment option and the benefit balance of the guaranteed retirement income account. The total benefit balance is a death benefit payable to a designated beneficiary. The total benefit balance fluctuates with investment returns and the reduction of the balance in the guaranteed retirement income account.

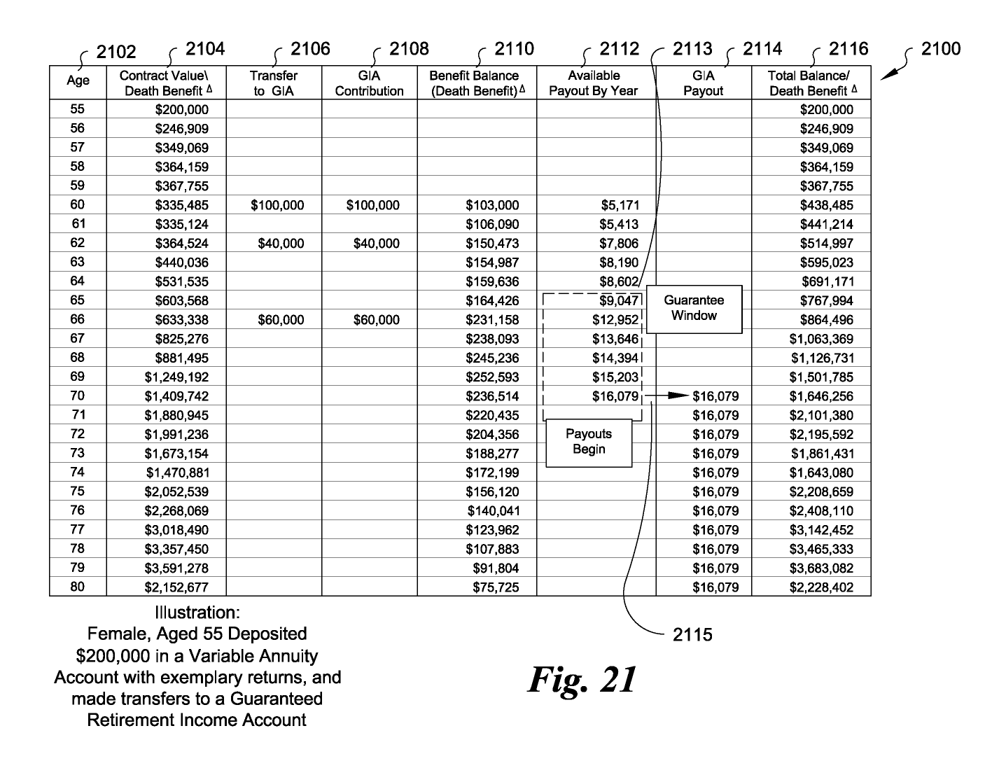

FIG. 21 shows a display, which may be displayed on a user device by an illustration module of a system, of an illustration 2100 of an account. The account is established by a female at age 55 with $200,000 in an investment option. Ages are shown in column 2102. The net asset value 2104 of the investment option increases for five years. At age 60, the contract owner transfers $100,000 from the investment option to establish a guaranteed retirement income account, as shown in columns 2106, 2108. The guaranteed retirement income account (or GIA, guaranteed income account) benefit balances are in column 2110, and grow with a credited interest rate. At age 60, the contract owner selected a target payout commencement date of age 68, with a seven year target payout commencement range 2113. At age 62, the owner transferred an additional $40,000 from the investment option to the GIA, and an additional $60,000 at age 68. The owner selected age 70 as her payout commencement date 2115, within the target payout commencement range, and thus received a payout calculated according to the fixed payout rates established at the commencement date and at the transfer dates. The level payout is $16,079 per year, as shown at 2114. The total balance of the investment option and the benefit balance is shown at 2116, and is a death benefit amount payable to a designated beneficiary.

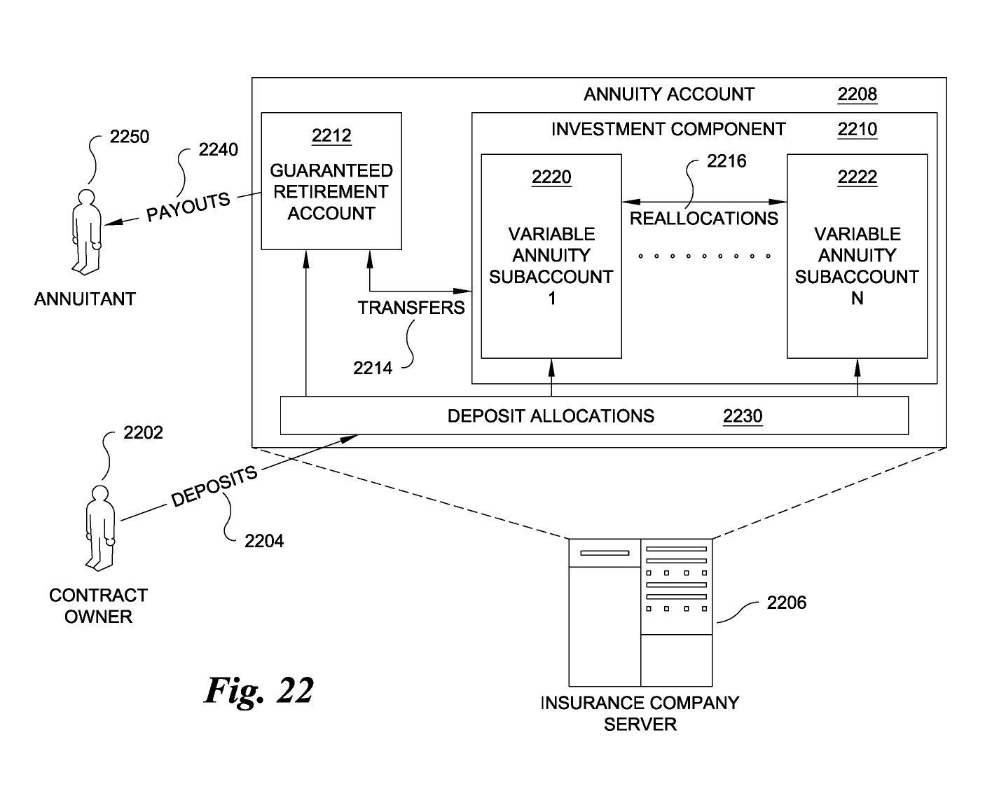

FIG. 22 is a schematic view of a system for administration of a guaranteed retirement income account as a subaccount in an annuity contract. In FIG. 22, contract owner 2202 establishes an annuity account 2208, administered by an insurance company server 2206. Owner 2202 makes deposits 2204 into annuity account 2208. Deposits are allocated by deposit allocations 2230, established by the owner, between a guaranteed retirement income account 2212 and, within investment component 2210, variable annuity subaccounts 1 2220 through variable annuity subaccount N 2222. Transfers 2214 may be made between investment component 2210 and guaranteed retirement income account 2212, subject to contractual restrictions, in accordance with instructions provided by the contract owner. For example, in FIG. 21, the owner transferred funds from an investment component to establish the guaranteed retirement income account and at two points thereafter. Returning to FIG. 22, reallocations 2216 may be made between variable annuity subaccounts at the contract owner s direction. At a payout date selected by the contract owner, payouts 2240 begin to be made for the guaranteed retirement income account 2212 to annuitant 2250, who may be the contract owner or a different person, such as a spouse. The contract owner advantageously was able to convert gains in the investment component into the greater certainty of the guaranteed retirement income account.

The present invention is operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with the invention may include means corresponding to each step in each method described herein. Each means may be implemented by a processor executing instructions contained in programs which may be stored in a storage medium and loaded into random access memory for execution. It will be appreciated that any of the steps in the methods in accordance with the invention described herein may be so implemented.

An exemplary advantage of a system and method in accordance with an embodiment is that an individual may structure a retirement plan that avoids the investment risk and longevity risk associated with defined contribution plans such as 401(k) plans and provides greater predictability as to future income than variable annuities and fixed deferred annuities, while providing flexibility in the timing of commencement of payments and the amount of payments, unlike fixed payout annuities.

While the foregoing invention has been described with reference to the above embodiments, various modifications and changes can be made without departing from the spirit of the invention. Accordingly, all such modifications and changes are considered to be within the scope of the appended claims.

What is claimed is:

1. A computer system for administration of a retirement income guarantee contract, comprising:
a communications module for receiving retirement income guarantee contract data including: an identity of a measuring life; an initial premium amount paid; a target payout commencement date; an age of at least the measuring life; a payout commencement range including the target payout commencement date; and further for providing an output signal indicative of a payout commencement date selected by a contract owner;
an account initiation module for determining payout rates fixed at the time of payment of the initial premium amount use in calculating income payments for payout commencing at dates within the payout commencement range; and credited interest rates fixed at the time of payment of the initial premium amount for determining increases in accumulation balance until the payout commencement date;
a contract generation module for receiving data from the communications module and the account initiation module, generating a contract based on the received data and furnishing the contract to the contract owner;
an accumulation administration module configured to determine an initial benefit balance based on the initial premium amount, updated benefit balances based on the benefit balance and the fixed credited interest rates, and store the determined benefit balances;
a payout administration module configured for, responsive to receiving from the communications module a payout commencement date within the payout commencement range and a payout value, determining a payout amount, paid at periodic intervals for a lifetime of the measuring life, based on the payout value as of the payout commencement date and the fixed payout rates.

2. The system of claim 1, further comprising a death benefit module for determining a death benefit amount equal to the benefit amount.

3. The system of claim 1, wherein the payout commencement range is an equal period of years before and after the target payout commencement date.

4. The system of claim 3, wherein the equal period of years is between two years and five years.

5. The system of claim 4, wherein the equal period of years is three years.

6. The system of claim 1, wherein the payout commencement range is a first period before the target payout commencement date and a second period, not equal to the first period, after the target payout commencement date.

7. The system of claim 1, wherein the account initiation module is for determining the payout rate by accessing a database storing payout rates determined by payout commencement date and current age of the measuring life.

8. The system of claim 7, wherein the database further identifies payout rates by gender of the measuring life.

9. The system of claim 1, further comprising a payment module for receiving the payout amount from the payout administration module and effecting payments.

10. The system of claim 1, wherein the payout administration module is further configured to, responsive to receiving a payout commencement date within the range and a payout amount less than a then-current account balance, determine an income amount based on the payout amount and the stored fixed payout rate.

11. The system of claim 1, wherein the payout administration module is further configured to, responsive to receiving a payout commencement date outside of the target range, determining a payout rate independent of the fixed rates.

12. The system of claim 1, wherein the credited interest rates a first credited rate applicable until the target payout commencement date and a second credited rate lower than the first credited rate applicable after the target payout commencement date.

13. The system of claim 1, further comprising a payment module configured to pay funds in accordance with the payout amount to an annuitant.

14. The system of claim 13, wherein the payment module is configured to print and mail checks.

15. The system of claim 13, wherein the payment module is configured to effect an electronic funds transfer to an account designated by the annuitant.

16. The system of claim 1, wherein each of said modules comprises a processor and a memory device in communication with the processor.

17. A computer system for administering a retirement income guarantee contract, comprising:
a communications module for receiving and transmitting data;
a data storage device for storing payout rate data and credited rate data;
an account initiation module for: causing to be stored in the data storage device retirement income guarantee contract data including: an identity of a contract owner, an initial premium amount paid, and a selected target payout commencement date, received via the communications module; a payout commencement date range; and for accessing from the data storage device payout rates fixed at the time of payment of the initial premium amount for determining income payments upon commencement of payouts at a payout date to be selected in the future by the contract owner within the payout commencement date range; and one or more crediting rates fixed at the time of payment of the initial premium amount for determining increases in an accumulation balance until commencement of payout at a payout date selected by the contract owner in the future; and
a contract generation module for generating a contract based on the retirement income guarantee contact data and furnishing the contract to the contract owner.

18. The computer system of claim 17, further comprising:
an accumulation module for accessing data stored by the account initiation module and updating the accumulation balance in accordance with the initial premium amount paid and the crediting rates.

19. The computer system of claim 17, further comprising:
a payout administration module configured for, responsive to receiving from the communications module a payout commencement date within the payout commencement range and a payout value, determining a payout amount, paid at periodic intervals for a lifetime of a measuring life, based on the payout value as of the payout commencement date and the fixed payout rates.

20. The computer system of claim 19, further comprising a payment system for receiving the output signal indicative of the payout amount from the payout administration module and effecting payments.

21. The computer system of claim 19, wherein the payout administration module is further configured to, responsive to receipt of a payout commencement date within the payout commencement range and a payout balance less than an accumulation balance, determine payout amounts based on the fixed payout rates and the payout amount.

22. The computer system of claim 21, further comprising an accumulation module configured to determine an initial benefit balance based on the initial premium amount, updated benefit balances based on the benefit balance and the fixed credited interest rates, and store the determined benefit balances, and further to determine an updated benefit balance after deducting the payout balance, and continuing to credit interest to the updated benefit balance after the payout commencement date.

23. The computer system of claim 17, further comprising an illustration module for providing prompts for display on a client device, receiving from the client device a desired retirement age and either a premium amount or a desired payout amount, and providing for display on the client device an illustration showing the premium amounts and payout amounts based on commencement of payout at the desired retirement age and at each age within a range including the desired retirement age.

24. The computer system of claim 23, wherein the illustration module is configured to access payout rates and credited rates from the data storage device.

25. The computer system of claim 17, wherein the contract generation module is configured to furnish the contract by printing and mailing a physical copy of the contract.

26. The computer system of claim 17, wherein the contract generation module is configured to furnish the contract by creating an electronic file of the contract and transmitting the electronic file to the contract owner via e-mail.

27. The computer system of claim 17, wherein the contract generation module is configured to furnish the contract to a contract owner for display on a handheld device.

28. The computer system of claim 17, wherein the payout commencement date range is a period of two to five years before and after the target a target annuitization date.

29. The computer system of claim 17, wherein the payout commencement date range is a predetermined range of measuring life ages.

30. The computer system of claim 17, further comprising a payout rate determination module for determining the fixed payout rates stored in the data storage device.

31. The computer system of claim 17, further comprising a commutation module for, responsive to receiving commutation instructions, determining an amount to be paid responsive to the commutation instructions.

32. The computer system of claim 17, further comprising a death benefit module for determining a death benefit payable upon death of the measuring life, the death benefit being equal an account balance if prior to the payout commencement date, and decreased by the sum of payout payments made if after the payout commencement date.

33. The computer system of claim 17, wherein the retirement income guarantee contract is one of a plurality of subaccounts within an annuity account, and wherein the account initiation module is further for increasing an accumulation balance by an amount of a transfer from one of the other of the subaccounts to the retirement income guarantee contract.

34. The computer system of claim 33, wherein the system is configured to transfer funds from the retirement income guarantee contract to the other subaccounts responsive to receipt of data indicative of contract owner instructions to transfer.

35. The computer system of claim 33, further comprising a death benefit module for determining a death benefit payable upon death of the measuring life, the death benefit being equal to a sum of a benefit balance of the retirement income guarantee contract and net asset values of each of the other subaccounts within the annuity account.

36. The computer system of claim 33, wherein the system is configured to, upon receipt of a deposit to the annuity account, allocate the deposit to the retirement income guarantee contract and to the other subaccounts in accordance with deposit allocation instructions provided by the account owner and stored in a memory device.

37. A computer-implemented method for administering a retirement income guarantee contract, comprising:
storing in a memory by an account initiation module including a processor, retirement income guarantee contract data including: an identity of a contract owner; an age of a measuring life; an initial premium amount paid; a selected target payout commencement date; a payout commencement date range including the target payout commencement date; an accumulation balance based on the initial premium amount paid;
accessing from a memory device by the account initiation module payout rates fixed at the time of payment of the initial premium amount for determining payout amounts upon commencement of payouts within the payout commencement date range, and one or more crediting rates fixed at the time of payment of the initial premium amount for determining increases in accumulation balance until commencement of payout at a payout date selected by the contract owner in the future; and
generating by a contract generation module a contract based on the retirement income guarantee contract data and furnishing the contract to the contract owner.

38. The computer-implemented method of claim 37, further comprising: accessing, by an accumulation module including a processor, data stored by the account initiation module and updating by the accumulation module the accumulation balance in accordance with the initial premium amount paid and the crediting rates.

39. The computer-implemented method of claim 37, further comprising:
determining, by a payout administration module including a processor, responsive to receiving a payout date, whether the payout date is within the payout date range;
responsive to determining that the annuitization date is within the payout date range, accessing by the payout administration module the fixed payout rates from the memory device, the updated accumulation balance and one of the fixed payout rates; and
determining by the payout administration module a payout amount based on the updated accumulation balance and the accessed fixed payout rate.

40. The computer-implemented method of claim 39, further comprising, on a periodic basis following a first payout, determining by the payout administration module an increased payout amount based on an amount of the first payout and a rate of increase stored at a time of payment of the initial premium amount.

41. The computer-implemented method of claim 37, wherein the payout commencement date range is defined by a window of equal duration before and after the target payout commencement date.

42. The computer-implemented method of claim 41, wherein the equal duration is between two and five years.

43. The computer-implemented method of claim 37, wherein the payout commencement date range is defined by a range of ages of the annuitant.

44. The computer-implemented method of claim 37, further comprising, on a periodic basis, accessing the updated accumulation balance by a commission module having a processor, determining by the commission module a commission amount based on the updated accumulation balance, and providing by the commission module an output signal to a payment system for payment of the determined commission amount.

45. The computer-implemented method of claim 37, wherein the furnishing comprises providing an image file of the contract for display on a client device.

46. A computer-readable medium having a plurality of instructions thereon which, when executed by a processor, cause the processor to:
store in a memory retirement income guarantee contract data including: an identity of a contract owner; an age of a measuring life; an initial premium amount paid; a selected target payout commencement date; a payout commencement date range including the target payout commencement date; and an accumulation balance based on the initial premium amount paid;
access from a memory device payout rates fixed at the time of payment of the initial premium amount for determining payout amounts upon commencement of payouts within the payout commencement date range, and one or more crediting rates fixed at the time of payment of the initial premium amount for determining increases in accumulation balance until commencement of payout at a payout date selected by the contract owner in the future; and
generate by a contract generation module a contract based on the retirement income guarantee contract data and furnishing the contract to the contract owner.

47. The computer-readable medium of claim 46 wherein the instructions further cause the processor to, responsive to receiving a payout commencement date not within the payout commencement date range, determine a payout amount independent of the fixed payout rates.

48. The computer-readable medium of claim 46 wherein the fixed payout rates include a first payout rate for a first period within the payout commencement date range and a second payout rate, higher than the first payout rate, for a second period, later than the first period, within the payout commencement date range.

49. The computer-readable medium of claim 46, wherein the payout commencement date range is a range of ages of the annuitant.

50. A computer-implemented method for administration of retirement income guarantee contract owned by a contract owner, comprising:
accessing by an accumulation module, having a processor, in an administration system from a memory device accumulation balance data and stored credited rate data;
determining by the accumulation module an updated accumulation balance based on the stored accumulation balance data and stored credited rate data;
determining by an administration system having a processor whether a payout date has been received;
responsive to determining that no payout date has been received, maintaining the accumulation balance without deduction for payouts; and, if a payout date has been received, determining a payout amount based on stored payout rates if the payout date is within a stored payout commencement date range, and independent of the stored payout rates otherwise;
determining by a death benefit module whether data indicative of a death of a measuring life has been received, and responsive to determining that no data indicative of the death of the measuring life has been received, storing in memory an indication that the measuring life is living; and
determining by a redemption module whether data indicative of a request for redemption of the accumulation balance has been received, and responsive to determining that no data indicative of a request for redemption has been received, maintaining the account.

51. The method of claim 50, wherein the steps of the method are performed at least annually.

52. The method of claim 50, wherein the credited rate data was stored at the time of initiation of the account.

53. A computer system for administration of a retirement income guarantee contract, comprising:
a processor and a memory storage device in communication with the processor;
the processor configured to:
access from the memory storage device data indicative of an identity of a measuring life, an age of a measuring life, an initial premium amount, and a selected target payout commencement date;
determine and store in the memory storage device a target payout commencement date range including the target payout commencement date;
determine, based on the target payout commencement date range and the age of the measuring life, fixed payout rates for payouts commencing at dates within the target payout commencement date range, and store the fixed payout rates in the memory storage device;
determine fixed interest rates for crediting interest to an account balance and store the fixed interest rates in the memory storage device;
determine and store in the memory storage device an initial account balance based on the initial premium amount;
determine and store in the memory storage device updated account balances periodically based on the initial account balance and the fixed interest rates;
determine whether a received payout commencement date is within the target payout commencement date range, and, responsive to determining that the received payout commencement date is within the target payout commencement date range, determine a payout amount based on an account balance as of the payout commencement date and one of the fixed payout rates applicable to the payout commencement date; and responsive to determining that the received payout commencement date is not within the target payout commencement date range, determine a payout amount independent of the fixed payout rates; and
provide an output signal having data indicative of the determined payout amount.

54. The computer system of claim 53, wherein the processor is configured to determine the fixed payout rates by accessing a table stored in the memory device mapping combinations of ages of measuring life at target payout date, years until target payout date from payment of premium, and gender of measuring life, to fixed payout rates.

55. The computer system of claim 54, wherein the target payout commencement date range is seven years.
